(19) United States
(12) Patent Application Publication
(10) Pub. No.: US 2010/0039235 A1
(43) Pub. Date: Feb. 18, 2010

(54) Antenna device and apparatus for communicating with RFID tag

(75) Inventor: Takuya Nagai, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/586,517

(22) Filed: Sep. 22, 2009

Related U.S. Application Data
(63) Continuation-in-part of application No. PCT/JP2008/054671, filed on Mar. 13, 2008.

(30) Foreign Application Priority Data
Mar. 29, 2007 (JP) 2007-089845

(51) Int. Cl. H04Q 5/22

(52) U.S. Cl. 340/10.1

(57) ABSTRACT

This disclosure discloses an antenna device connected to a signal generating device configured to generate a communication signal to a communication target, comprising: a magnetic-field radiation antenna and an electric-field radiation antenna configured to carry out information transmission and reception via radio communication at substantially the same frequency with each other; and a selection connecting device configured to selectively connect either one of the magnetic-field radiation antenna and the electric-field radiation antenna to the signal generating device.

### CROSS-REFERENCE TO RELATED APPLICATION

This is a CIP application PCT/JP2008/054671, filed Mar. 13, 2008, which was not published under PCT article 21(2) in English.

### BACKGROUND OF THE INVENTION

1. Field of the Invention

The present invention relates to an antenna device configured to conduct radio communication with a communication target using an antenna. The present invention also relates to an apparatus for communicating with a radio frequency identification (RFID) tag configured to conduct radio communication with an RFID tag.

2. Description of the Related Art

Prior art references of selectively using a plurality of antennas in radio communication with a communication target through an antenna have been known. An example of the known arts is an art described in JP, A, 2006-324821, for example.

In the above prior art references, two antennas with different directivities are selectively used according to a distance to the communication target. For that purpose, a distance to the communication target is measured using an ultrasonic beam at first. Then, output power is set according to the measured distance, and either one of the antennas is selectively used in accordance with the setting. As a result, optimal communication can be made according to the distance to the communication target.

However, with the above prior art references, an operator needs to make distance measurement at first before start of the communication. This may inevitably impose a troublesome task for the operator, and thus increase an operation burden on the operator.

### SUMMARY OF THE INVENTION

The present invention has an object to provide an antenna device and an apparatus for communicating with an RFID tag that can automatically conduct optimal communication according to a distance to a communication target without increasing an operation burden on an operator.

### BRIEF DESCRIPTION OF THE DRAWING

FIG. 1 is a system configuration diagram illustrating an RFID tag manufacturing system including an apparatus for communicating with an RFID tag of an embodiment of the present invention.

FIG. 2 is a perspective view illustrating an entire structure of an apparatus for communicating with an RFID tag.

FIG. 3 is a perspective view illustrating a structure of an internal unit inside an apparatus for communicating with an RFID tag.

FIG. 4 is a plan view illustrating a structure of an internal unit inside an apparatus for communicating with an RFID tag.

FIG. 5 is an enlarged plan view schematically illustrating a detailed structure of a cartridge.

FIG. 6A is a conceptual view on arrow illustrating a conceptual configuration of an RFID tag circuit element provided at a base tape fed out of a first roll seen from its upper face. FIG. 6A substantially corresponds to a case when seen from a D direction in FIG. 5.

FIG. 6B is a partially extracted enlarged view of FIG. 6A.

FIG. 7 is a functional block diagram illustrating a control system of an apparatus for communicating with an RFID tag, which is an embodiment of the present invention.

FIG. 8 is a functional block diagram schematically illustrating a configuration of an antenna unit for information acquisition.

FIG. 9 is a perspective view illustrating a layout configuration of a magnetic-field radiation antenna and an electric-field radiation antenna arranged on a back face side of a communication wall portion and respective communicable areas.

FIG. 10A is a diagram conceptually illustrating an example of a circuit configuration of a specific matching circuit.

FIG. 10B is a diagram conceptually illustrating another example of a circuit configuration of a specific matching circuit.

FIG. 11A is a top view illustrating an example of an appearance of an RFID label formed upon completion of information writing or reading of an RFID tag circuit element for label production and cutting of a tag label tape with print by an apparatus for communicating with an RFID tag.

FIG. 11B is a bottom view of FIG. 11A.

FIG. 12A is a view obtained by rotating the cross sectional view by XIIIA-XIIIA′ section in FIG. 11A counterclockwise by 90°.

FIG. 12B is a view obtained by rotating the cross sectional view by XIIIB-XIIIB′ section in FIG. 11A counterclockwise by 90°.

FIG. 13 is a flowchart illustrating a detailed procedure relating to information acquisition processing executed by a CPU of a control circuit.

FIG. 14 is a flowchart illustrating a detailed procedure of scanning processing at Step S200 in FIG. 13.

FIG. 15 is a functional block diagram schematically illustrating a configuration of an antenna unit for information acquisition when a loop antenna is used as an electric-field radiation antenna.

FIG. 16 is a perspective view illustrating a layout configuration of a micro loop-antenna type magnetic-field radiation antenna and a large-sized loop-antenna type electric-field radiation antenna arranged on a back face side of a communication wall portion and respective communicable areas. FIG. 16 is a diagram corresponding to FIG. 9.

FIG. 17 is a flowchart illustrating a detailed procedure relating to information acquisition processing when short distance communication and long distance communication are repeated alternately. FIG. 17 is a diagram corresponding to FIG. 13.

FIG. 18 is a functional block diagram schematically illustrating a configuration of an antenna unit for information acquisition when a magnetic-field radiation antenna of a micro loop antenna and an electric-field radiation antenna of a dipole-antenna are partially made common.

FIG. 18 is a diagram corresponding to FIG. 8.

FIG. 19 is a functional block diagram schematically illustrating a configuration of an antenna unit for information acquisition when a magnetic-field radiation antenna of a micro loop antenna and an electric-field radiation antenna of a large-sized loop antenna are partially made common.

FIG. 20 is a functional block diagram schematically illustrating a configuration of an antenna unit for information acquisition when a magnetic-field radiation antenna of a micro loop antenna and an electric-field radiation antenna of a dipole-antenna are partially made common and matching circuits are also made common. FIG. 20 is a diagram corresponding to FIGS. 8 and 18.

FIG. 21 is a functional block diagram schematically illustrating a configuration of an antenna unit for information acquisition when a magnetic-field radiation antenna of a micro loop antenna and an electric-field radiation antenna of a large-sized loop antenna are partially made common and matching circuits are also made common.

FIG. 22 is a functional block diagram schematically illustrating a configuration of an antenna unit for information acquisition a magnetic-field radiation antenna of a micro loop antenna and an electric-field radiation antenna of a large-sized loop antenna are used so as to form a Yagi antenna. FIG. 22 is a diagram corresponding to FIG. 8.

### DETAILED DESCRIPTION OF THE PREFERRED EMBODIMENTS

An embodiment of the present invention will be described below referring to the attached drawings. This embodiment is an embodiment when the present invention is applied to a manufacturing system of an RFID label.

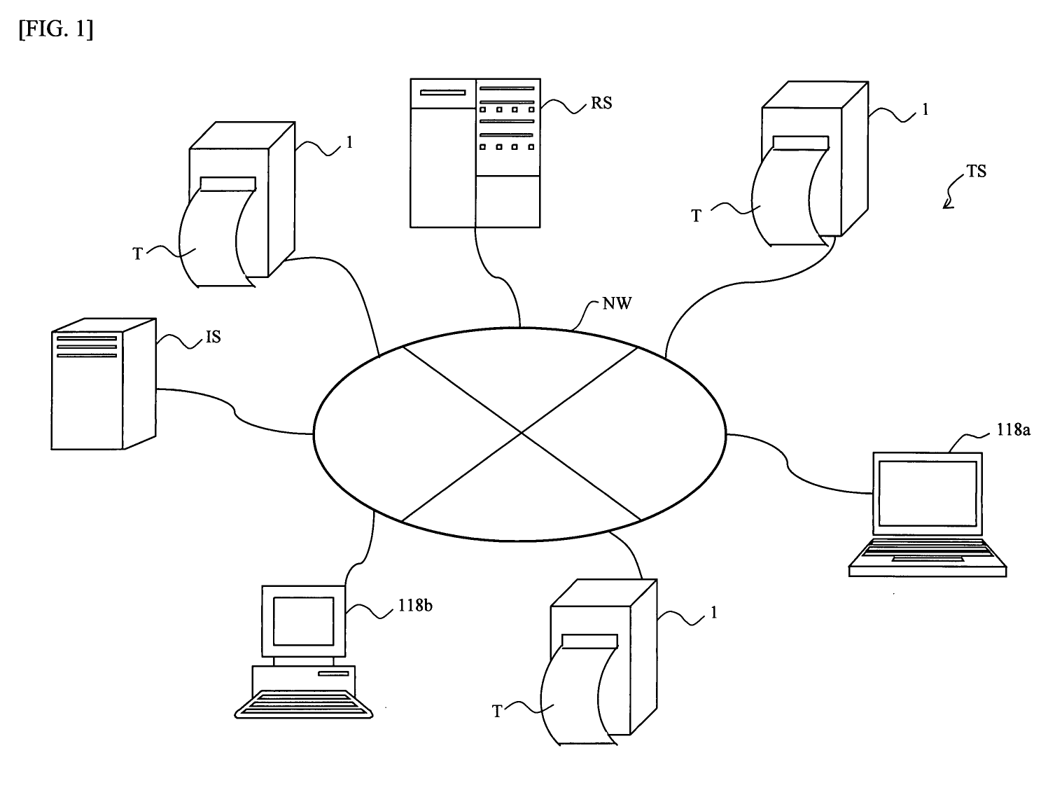

An RFID tag manufacturing system including an apparatus for communicating with an RFID tag of this embodiment is described by using FIG. 1.

In an RFID tag manufacturing system TS shown in FIG. 1, an apparatus 1 for communicating with an RFID tag as apparatus for communicating with an RFID tag as is connected to a route server RS, a plurality of information servers IS, a terminal 118a, and a general-purpose computer 118b through a wired or wireless communication line NW. The terminal 118a and the general-purpose computer 118b are collectively referred to simply as “PC 118” below as appropriate.

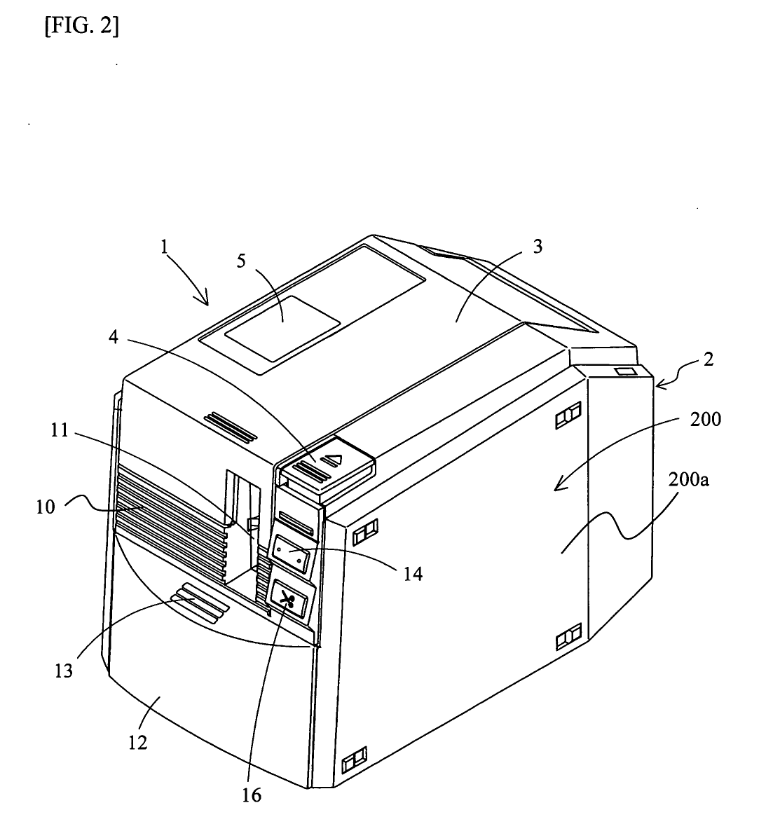

As shown in FIG. 2, the apparatus 1 for communicating with an RFID tag produces an RFID label with print using a tape provided with an RFID tag circuit element for label production in the apparatus and reads information, in other words, obtains information, from the RFID tag circuit element for information acquisition outside the apparatus on the basis of an operation from the PC 118. The RFID tag circuit element corresponds to a communication target. Processing modes of the apparatus 1 for communicating with an RFID tag include a label production processing mode in which the RFID label with print is produced and an information acquisition processing mode in which information reading from the RFID tag circuit element for information acquisition is carried out.

The apparatus 1 for communicating with an RFID tag has an apparatus main body 2 having a substantially hexagonal, in other words, substantially cubic housing 200 on an outline, and an opening and closing lid 3 disposed so as to be opened and closed on an upper face of the apparatus main body 2. The opening and closing lid 3 may be detachably attached to the upper face of the apparatus main body 2.

The housing 200 of the apparatus main body 2 includes a front wall 10 located at a front side of the apparatus, that is, the left front side in FIG. 2 and provided with a label carry-out exit 11 configured to discharge an RFID label T (which will be described later) produced inside the apparatus main body 2 to the outside. The housing 200 is also provided with a front lid 12 disposed below the label carry-out exit 11 in the front wall 10 and having its lower end rotatably supported.

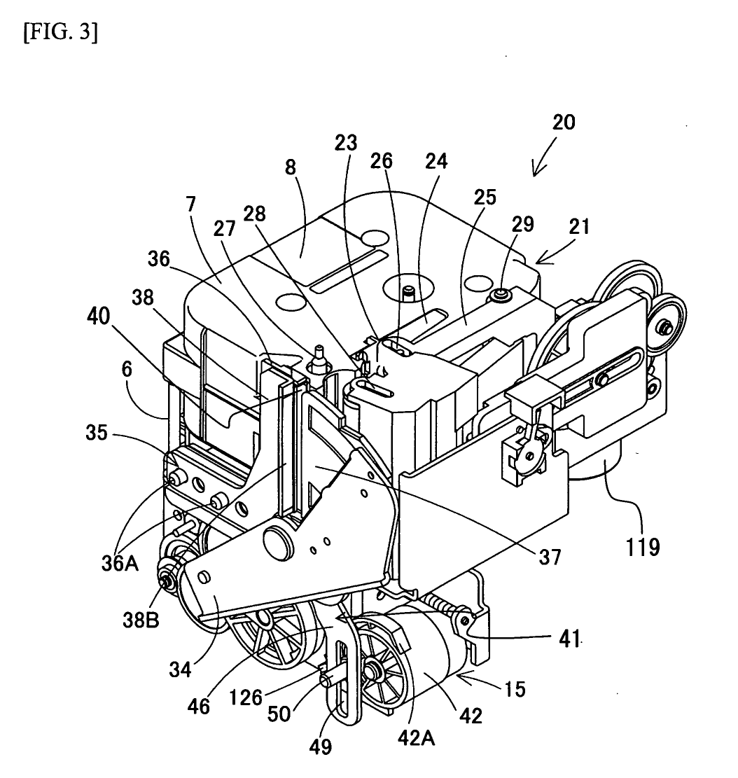

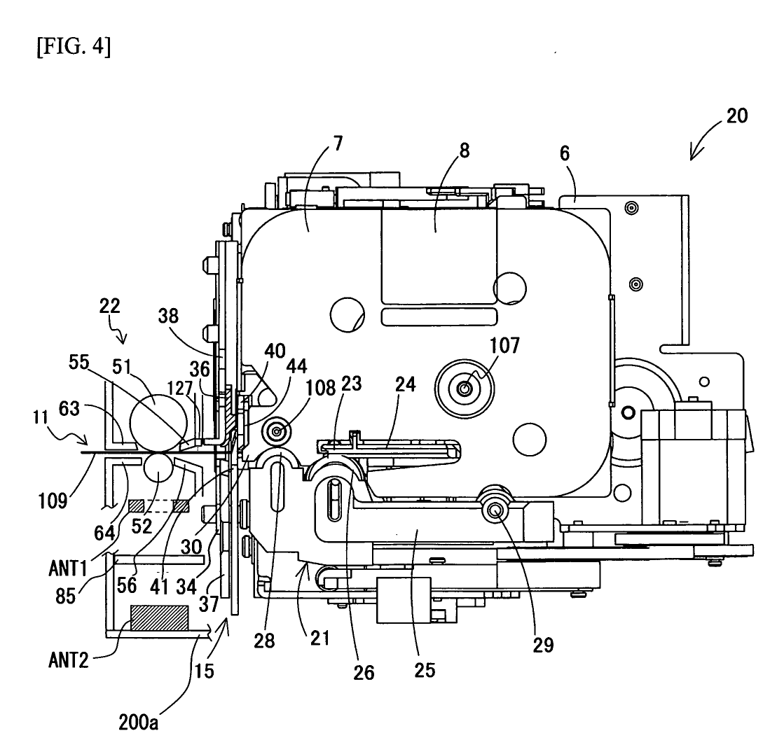

The front lid 12 is provided with a pusher portion 13. The front lid 12 is opened forward by pushing in the pusher portion 13 from above. At one end portion of the front wall 10, a power button 14 configured to power on or off the apparatus 1 for communicating with an RFID tag is disposed. Below the power button 14, a cutter driving button 16 is disposed. The cutter driving button 16 is disposed to drive a cutting mechanism 15 (See FIG. 3, which will be described later) disposed in the apparatus main body 2 through a manual operation of the operator. When the cutter driving button 16 is pressed, a tag label tape 109 with print (See FIG. 4, which will be described later) is cut to a desired length so as to produce the RFID label T.

The opening and closing lid 3 is rotatably supported at an end portion on the right depth side in FIG. 2 of the apparatus main body 2. The opening and closing lid 3 is urged in an opening direction all the time through an urging member such as a spring. When an opening and closing button 4 arranged adjacent to the opening and closing lid 3 on the upper face of the apparatus main body 2 is pressed, lock between the opening and closing lid 3 and the apparatus main body 2 is released. As a result, the opening and closing lid 3 is opened by an action of the urging member. At the center side portion of the opening and closing lid 3, a see-through window 5 covered by a transparent cover is disposed.

An internal unit 20 inside the apparatus 1 for communicating with an RFID tag is described by using FIG. 3. However, a loop antenna ANT1 for label production and an antenna unit ANT2 for information acquisition, which will be described later, are not shown. In FIG. 3, the internal unit 20 generally includes a cartridge holder 6 configured to accommodate a cartridge 7, a printing mechanism 21 provided with a print head 23, the cutting mechanism 15 provided with a fixed blade 40 and a movable blade 41, and a half cut unit 35. The half cut unit 35 is located on a downstream side in a tape feeding direction of the fixed blade 40 and the movable blade 41 and provided with a half cutter 34. The print head 23 is a so-called thermal head.

On an upper face of the cartridge 7, a tape identification display portion 8 that displays tape width, tape color, etc. of a base tape 101 built in the cartridge 7, for example, is disposed. Also, in the cartridge holder 6, a roller holder 25 is rotatably supported by a support shaft 29. The roller holder 25 can be switched between a printing position, that is, a contact position (see FIG. 4, which will be described later) and a release position, that is, a separated position by a switching mechanism. At this roller holder 25, a platen roller 26 and a tape feeding roller 28 are rotatably disposed. When the roller holder 25 is switched to the printing position, the platen roller 26 and the tape feeding roller 28 are pressed onto the print head 23 and the feeding roller 27.

The print head 23 is provided with a large number of heater elements. The print head 23 is mounted to a head mounting portion 24 disposed on the cartridge holder 6.

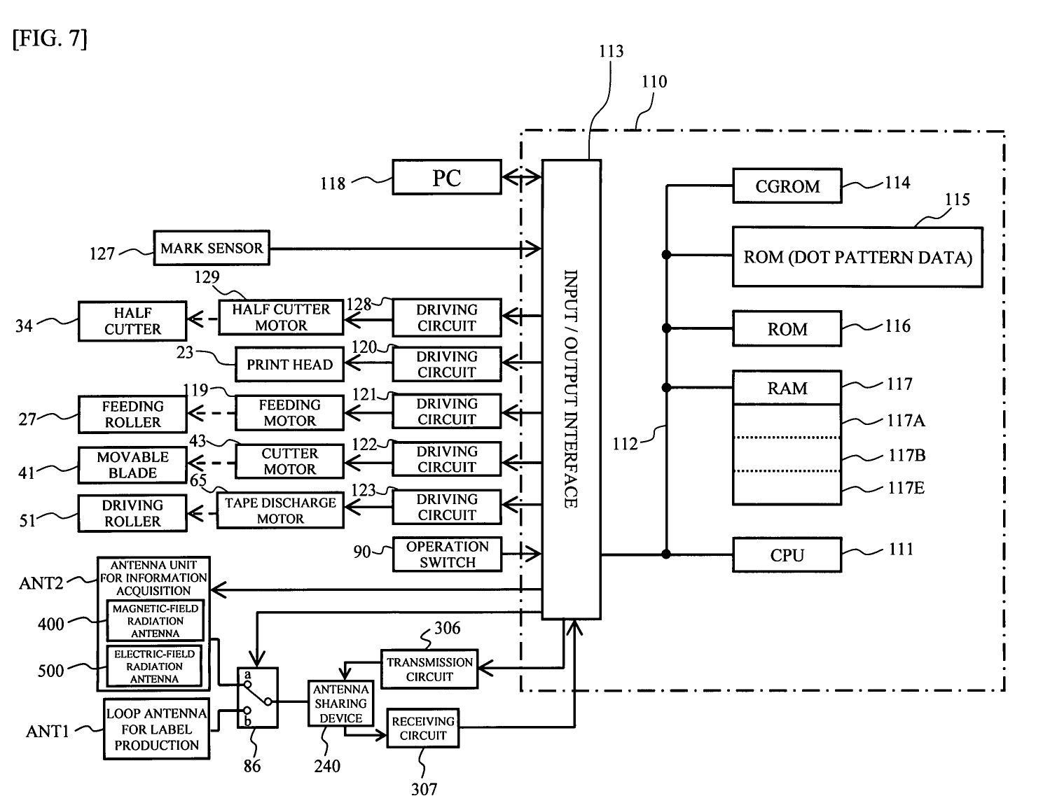

The cutting mechanism 15 is provided with the fixed blade 40 and the movable blade 41 including a metal member. A driving force of a cutter motor 43 (See FIG. 7, which will be described later) is transmitted to a shank portion 46 of the movable blade 41 through a cutter helical gear 42, a boss 50, and a long hole 49. As a result, the movable blade is rotated, which performs a cutting operation with the fixed blade 40. This cutting state is detected by a micro switch 126 switched by an action of a cam 42A for cutter helical gear.

In the half cut unit 35, a receiver 38 and the half cutter 34 are arranged facing each other. Moreover, in the half cut unit 35, a first guide portion 36 and a second guide portion 37 are mounted to a side plate 44 (See FIG. 4, which will be described later) by a guide fixing portion 36A. The half cutter 34 is rotated by a driving force of a half cutter motor 129 (See FIG. 7, which will be described later) about a predetermined rotation fulcrum, not shown. At an end portion of the receiver 38, a receiving face 38B is formed.

As shown in FIG. 4, the cartridge holder 6 accommodates the cartridge 7. At this time, a direction in a width direction of the tag label tape 109 with print is a vertical direction. The tag label tape 109 with print is discharged from a tape discharge portion 30 of the cartridge 7 and further discharged from the label carry-out exit 11.

In the internal unit 20, a label discharge mechanism 22, the loop antenna ANT1 for label production, and the antenna unit ANT2 for information acquisition are disposed. The antenna unit ANT2 for information acquisition corresponds to an antenna device.

The loop antenna ANT1 for label production is provided with a communicable area on an internal side of the housing 200 and configured so that information transmission and reception is possible with an RFID tag circuit element To for label production. The RFID tag circuit element To for label production is provided on the tag label tape 109 with print. The antenna unit ANT2 for information acquisition is arranged in the vicinity on the inside of a side wall face 200a on the right front side in FIG. 2 of the housing 200 and is provided with a communicable area on the outside of the housing 200. The antenna unit ANT2 for information acquisition is configured capable of information transmission and reception with respect to the RFID tag circuit element To for information acquisition located outside the housing 200. Between the loop antenna ANT1 for label production and the antenna unit ANT2 for information acquisition, a shield member 85 made of metal, for example, in order to shield a magnetic flux is disposed. The magnetic flux is generated from the loop antenna ANT1 for label production and the antenna unit ANT2 for information acquisition.

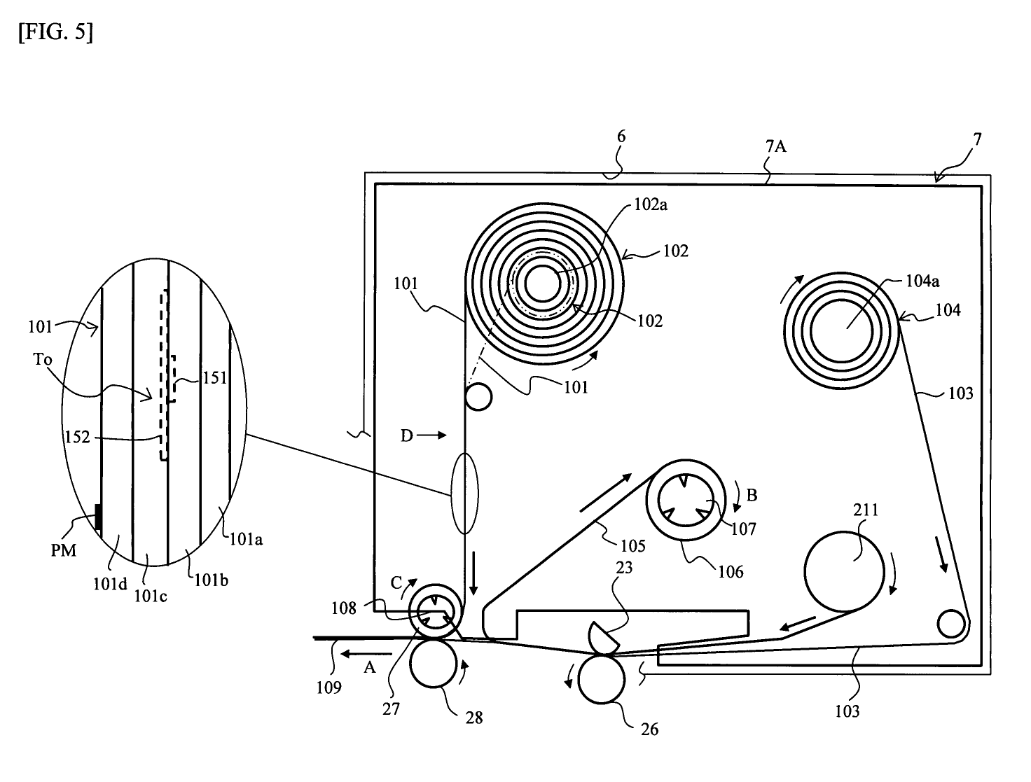

The label discharge mechanism 22 discharges the tag label tape 109 with print after it is cut in the cutting mechanism 15, in other words, an RFID label T, (the same applies to the following) from the label carry-out exit 11 (See FIG. 2). That is, the label discharge mechanism 22 includes a driving roller 51, a pressure roller 52 and a mark sensor 127. The driving roller 51 is rotated by a driving force of a tape discharge motor 123 (See FIG. 7, which will be described later). The pressure roller 52 is opposed to the driving roller 51 with the tag label tape 109 with print between them. The mark sensor 127 is configured to detect an identification mark PM (See FIG. 5, which will be described later) disposed on the tag label tape 109 with print. At this time, the first guide walls 55, 56 and second guide walls 63, 64 that guide the tag label tape 109 with print to the label carry-out exit 11 and the loop antenna ANT1 for label production are disposed inside the label carry-out exit 11. The first guide walls 55, 56 and the second guide walls 63, 64 are integrally formed, respectively. The first guide walls 55, 56 and the second guide walls 63, 64 are arranged at a discharge position of the tag label tape 109 with print, that is, the RFID label T, cut by the fixed blade 40 and the movable blade 41. The first guide walls 55, 56 and the second guide walls 63, 64 are arranged so that they are separated from each other with a predetermined interval.

A feeding roller driving shaft 108 and a ribbon take-up roller driving shaft 107 give a feeding driving force of the tag label tape 109 with print and an ink ribbon 105 (which will be described later), respectively. The feeding roller driving shaft 108 and the ribbon take-up roller driving shaft 107 are rotated and driven in conjunction with each other.

A detailed structure of the cartridge 7 is described by using FIG. 5. In FIG. 5, the cartridge 7 includes a housing 7A, a first roll 102, a second roll 104, a ribbon-supply-side roll 211, a ribbon take-up roller 106 and the feeding roller 27. The first roll 102 is arranged inside the housing 7A and is wound with the base tape 101 in the band state. The second roll 104 is wound with a transparent cover film 103 having substantially the same width as that of the base tape 101. The ribbon-supply-side roll 211 feeds out the ink ribbon 105. The ribbon take-up roller 106 winds up the ribbon 105 after printing. The feeding roller 27 is rotatably supported in the vicinity of the tape discharge portion 30 of the cartridge 7. The first roll 102 and the second roll 104 are actually wound in a swirl state but shown concentrically in the figure for simplification. The ink ribbon 105 is a so-called thermal transfer ribbon. However, the ink ribbon 105 is not needed when the print-receiving tape is a thermal tape.

The feeding roller 27 presses and bonds the base tape 101 and the cover film 103 together so as to form the tag label tape 109 with print. Also, the feeding roller 27 feeds the tape in a direction shown by an arrow A in FIG. 5 and also functions as a tape feeding roller.

In the first roll 102, the base tape 101 is wound around a reel member 102a. On the base tape 101, a plurality of RFID tag circuit elements To for label production is sequentially formed in a longitudinal direction with a predetermined equal interval. The base tape 101 has a four-layered structure as shown in a partially enlarged view in FIG. 5 and is constructed in lamination in an order of an adhesive layer 101a, a colored base film 101b, an adhesive layer 101c, and a separation sheet 101d from a side wound inside, that is, the right side in FIG. 5, toward the opposite side, that is, the left side in FIG. 5 in this example. The adhesive layer 101a includes an appropriate adhesive material. The base film 101b includes PET, that is, polyethylene terephthalate, for example. The adhesive layer 101c includes an appropriate adhesive material. The separation sheet 101d corresponds to a separation material.

On a back side of the base film 101b, that is, the left side in FIG. 5, a tag antenna 152 for information transmission and reception is disposed integrally. The tag antenna 152 is a dipole antenna in this example. An IC circuit part 151 storing information is formed so as to be connected to the tag antenna 152. The RFID tag circuit element To for label production includes the tag antenna 152 and the IC circuit part 151.

On a front side of the base film 101b, that is, a right side in FIG. 5, the adhesive layer 101a that bonds the cover film 103 later is formed, while on a back side of the base film 101b, that is, a left side in FIG. 5, the separation sheet 101d is bonded to the base film 101b by the adhesive layer 101c provided so as to include the RFID tag circuit element To for label production.

When the RFID label T finally completed in the label state is to be affixed to a predetermined article, for example, the separation sheet 101d enables adhesion to the article, for example, by the adhesive layer 101c through separation of the separation sheet. Also, on a surface of the separation sheet 101d, at a predetermined position corresponding to each RFID tag circuit element To for label production, a predetermined identification mark PM for feeding control is disposed. In this embodiment, the identification mark PM for feeding control is disposed at a position on the further front from a distal end of the tag antenna 152 in the front side in the feeding direction, as the predetermined position. In this embodiment, an identification mark is painted in black. Alternatively, it may be a drilled hole penetrating the base tape 101 by laser machining, for example, or it may be a Thomson type machined hole, for example.

The second roll 104 has the cover film 103 wound around a reel member 104a. The cover film 103 is fed out of the second roll 104. The ribbon 105 is brought into contact with the back face of the cover film 103 by being pressed by the print head 23. The ribbon-supply-side roll 211 and the ribbon take-up roller 106 are arranged on the back face side of the cover film, that is, the side to be bonded to the base tape 101. The ribbon 105 is driven by the ribbon-supply-side roll 211 and the ribbon take-up roller 106.

The driving force of a feeding motor 119 is transmitted to the ribbon take-up roller driving shaft 107 and the feeding roller driving shaft 108 through a gear mechanism, not shown. As a result, the ribbon take-up roller 106 and the feeding roller 27 are driven and rotated in conjunction. The feeding motor 119 (See FIG. 3 and FIG. 7, which will be described later) is constructed by a pulse motor, for example. The feeding motor 119 and the gear mechanism are provided outside the cartridge 7. The print head 23 is disposed in the upstream side in the feeding direction of the cover film 103 from the feeding roller 27.

In the above construction, the base tape 101 fed out of the first roll 102 is supplied to the feeding roller 27. On the other hand, as for the cover film 103 fed out of the second roll 104, the ink ribbon 105 is brought into contact with the back face of the cover film 103.

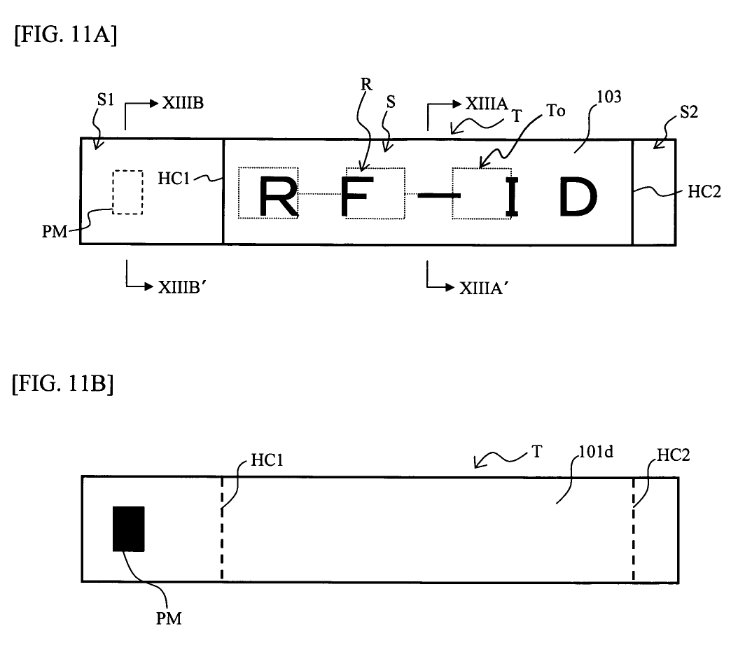

Then, the cartridge 7 is attached to the cartridge holder 6. After that, when the roll holder 25 moves from the release position to the print position, the cover film 103 and the ink ribbon 105 are interposed and supported between the print head 23 and the platen roller 26. Moreover, the base tape 101 and the cover film 103 are interposed and supported between the feeding roller 27 and the tape feeding roller 28. Then, the ribbon take-up roller 106 and the feeding roller 27 are rotated and driven by the driving force of the feeding motor 119 in a direction shown by an arrow B and an arrow C in FIG. 5, respectively, in synchronization with each other. At this time, the feeding roller driving shaft 108, the tape feeding roller 28 and the platen roller 26 are connected through the gear mechanism, not shown. As a result, with the driving of the feeding roller driving shaft 108, the feeding roller 27, the tape feeding roller 28, and the platen roller 26 are rotated. As a result, the base tape 101 is fed out of the first roll 102 and supplied to the feeding roller 27 as described above. On the other hand, the cover film 103 is fed out of the second roll 104. Also, a print-head driving circuit 120 (See FIG. 7, which will be described later) electrifies the plurality of heater elements of the print head 23. As a result, a print character string R (See FIG. 11, which will be described later) is printed on the back face of the cover film 103. The print character string R corresponds to the RFID tag circuit element To for label production on the base tape 101 to become a bonding target. Then, the base tape 101 and the cover film 103 on which the printing has been finished are bonded together by the feeding roller 27 and the tape feeding roller 28 to be integrated and formed as the tag label tape 109 with print. The tag label tape 109 with print is fed out of the cartridge 7 through the tape discharge portion 30 (See FIG. 4). The ink ribbon 105 finished with printing on the cover film 103 is taken up by the ribbon take-up roller 106 by driving of the ribbon take-up roller driving shaft 107.

Then, the loop antenna ANT1 for label production carries out information reading or writing for the RFID tag circuit element To for label production on the tag label tape 109 with print created by bonding as above. After that, the cutting mechanism 15 cuts off the tag label tape 109 with print automatically or by operating the cutter driving button 16 (See FIG. 2). As a result, the RFID label T is produced. This RFID label T is further discharged from the label carry-out exit 11 (See FIGS. 2 and 4) by the label discharge mechanism 22.

The RFID tag circuit element To for label production is provided on the base tape 101 fed out of the first roll 102.

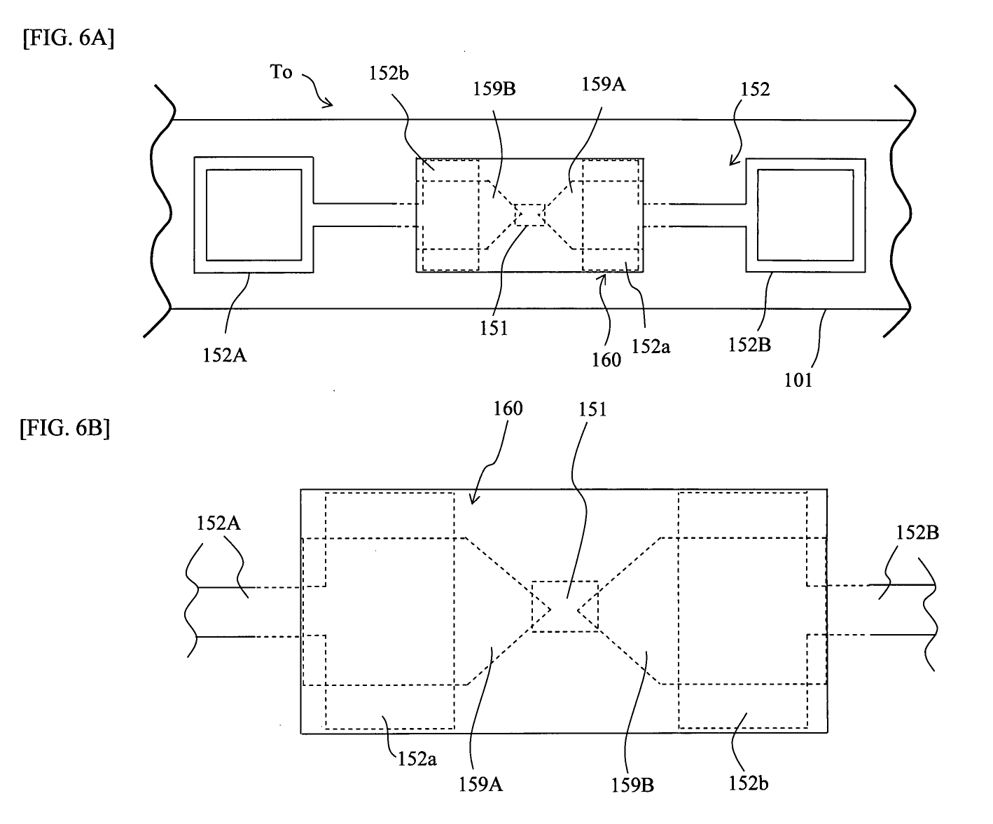

As shown in FIG. 6A and FIG. 6B, the RFID tag circuit element To for label production includes the tag antenna 152 for information transmission and reception and an IC circuit part 151 connected to the tag antenna 152 and storing the information. The tag antenna 152 is a so-called dipole antenna. The tag antenna 152 has the IC circuit part 151 disposed substantially in a straight manner in an intermediate portion of the two antenna elements on one side and the other side.

That is, on the base tape 101, specifically on the above-described base film 101b, for example, two antenna elements 152A, 152B are disposed along the longitudinal direction so as to oppose each other. On the opposing sides of the antenna elements 152A, 152B, rectangular connection end portions 152a, 152b protruding in a hammer state are formed in this example.

A protective film 160 covers the IC circuit part 151 and its connection terminals 159A, 159B from above. The protective film 160 is formed in a thin and wide rectangular body for holding the IC circuit part 151 and the connection terminals 159A, 159B. A lower face of the IC circuit part 151 is exposed from a center part of the protective film 160 in this example. The connection terminals 159A, 159B are located at a lower part of the protective film 160. The connection terminals 159A, 159B are provided with opposing portions extending in a triangular state from square base part. Tip ends of the opposing portions are connected to an electrode portion on the lower face of the IC circuit part 151.

The RFID tag circuit element for information acquisition from which information is read outside the housing 200 also has the structure similar to that shown in FIG. 6A and FIG. 6B. The RFID tag circuit element for information acquisition is also provided with the dipole type tag antenna 152.

That is, the RFID tag circuit element To for label production has the tag antenna 152 and the IC circuit part 151. The tag antenna 152 is configured to carry out signal transmission and reception contactlessly by magnetic induction method or electric wave method with the loop antenna ANT1 for label production on the side of the apparatus 1 for communicating with an RFID tag. The IC circuit part 151 is connected to the tag antenna 152. The RFID tag circuit element To for information acquisition also has the tag antenna 152 and the IC circuit part 151 similarly to the above. The tag antenna 152 is configured to carry out signal transmission and reception contactlessly by magnetic induction method or electric wave method with the antenna unit ANT2 for information acquisition on the side of the apparatus 1 for communicating with an RFID tag. The IC circuit part 151 is connected to the tag antenna 152.

A control system of the apparatus 1 is described by using FIG. 7. As shown in FIG. 7, on a control substrate, not shown, of the apparatus 1 for communicating with an RFID tag, a control circuit 110 is disposed.

In the control circuit 110, a CPU 111 that controls each equipment, an input/output interface 113 connected to the CPU 111 through a data bus 112, a CGROM 114, ROMs 115, 116, and a RAM 117 are disposed.

In the ROM 116, a print driving control program, a cutting driving control program, a tape discharge program, a transmission program, a receiving program, and other various programs required for control of the apparatus 1 for communicating with an RFID tag are stored. The print driving control program reads data of a print buffer in accordance with an operation input signal from the PC 118 and drives the print head 23, the feeding motor 119, and the tape discharge motor 65. The cutting driving control program feeds the tag label tape 109 with print to a cut position by driving the feeding motor 119 when printing is finished. Then, the cutting driving control program cuts the tag label tape 109 with print by driving the cutter motor 43. The tape discharge program drives the tape discharge motor 65 and forcedly discharges the tag label tape 109 with print which has been cut, that is, the RFID label T, from the label carry-out exit 11. The transmission program creates access information such as an inquiry signal and a writing signal to the RFID tag circuit element To for label production or the RFID tag circuit element To for information acquisition and outputs it to a transmission circuit 306. The receiving program processes a signal such as a response signal input from a receiving circuit 307. The CPU 111 executes various calculations on the basis of the various programs stored in the ROM 116.

In the RAM 117, a text memory 117A, a print buffer 117B, a parameter storage area 117E, for example are disposed. In the text memory 117A, document data input from the PC 118 is stored. In the print buffer 117B, dot pattern data, such as the dot patterns for print, for example, a plurality of characters and symbols and applied pulse number, which is an energy amount forming each dot, are stored. The print head 23 carries out dot printing according to the dot pattern data stored in this print buffer 117B. In the parameter storage area 117E, various calculation data, tag identification information, that is, a tag ID, for example, of the RFID tag circuit element To for information acquisition when information reading, that is, acquisition, is carried out, are stored.

To the input/output interface 113, the PC 118, the print-head driving circuit 120 that drives the print head 23, a feeding motor driving circuit 121 that drives the feeding motor 119, a cutter motor driving circuit 122 that drives the cutter motor 43, a half-cutter motor driving circuit 128 that drives a half-cutter motor 129, a tape discharge motor driving circuit 123 that drives the tape discharge motor 65, a transmission circuit 306, a receiving circuit 307, the mark sensor 127 that detects the identification mark PM are connected. The transmission circuit 306 functions as a signal generating device. The transmission circuit 306 generates a carrier wave and also modulates the carrier wave on the basis of a control signal input from the control circuit 110 and outputs an interrogation wave. The carrier wave is used for making an access to the RFID tag circuit element To for label production or information acquisition, that is, reading and writing, through the loop antenna ANT1 for label production or the antenna unit ANT2 for information acquisition. The receiving circuit 307 demodulates a response wave, that is, a response signal, and outputs it to the control circuit 110. The response wave is received from the RFID tag circuit element To for label production or the RFID tag circuit element To for information acquisition through the loop antenna ANT1 for label production or the antenna unit ANT2 for information acquisition.

The transmission circuit 306 and the receiving circuit 307 are connected to the loop antenna ANT1 for label production and the antenna unit ANT2 for information acquisition through an antenna sharing device 240 and a switching circuit 86. The switching circuit 86 switches the antenna sharing device 240 on the basis of a control signal input from the control circuit 110 through the input/output interface 113. The antenna sharing device 240 is switched to be selectively connected to the loop antenna ANT1 for label production or the antenna unit ANT2 for information acquisition. Specifically, the control circuit 110 controls the switching circuit 86 to a “b” position in the figure where the antenna sharing device 240 and the loop antenna ANT1 for label production are connected when the label production processing mode is selected as the processing mode. Also, the control circuit 110 controls the switching circuit 86 to a “a” position in the figure where the antenna sharing device 240 and the antenna unit ANT2 for information acquisition are connected when the information acquisition processing mode is selected as the processing mode.

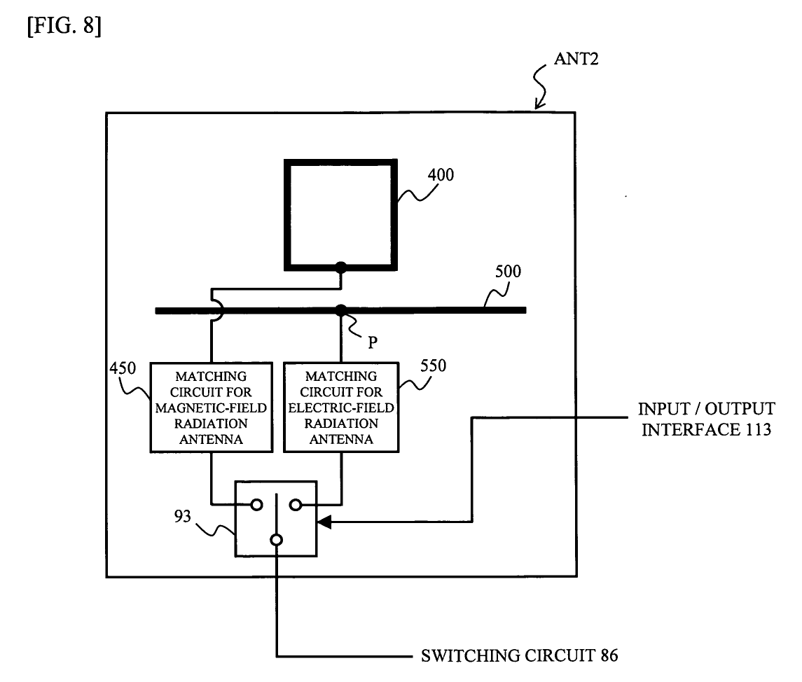

The antenna unit ANT2 for information acquisition includes a magnetic-field radiation antenna 400 constructed by a micro loop antenna (See FIG. 8, which will be described later), for example, and an electric-field radiation antenna 500 constructed by a dipole antenna (See FIG. 8, which will be described later), for example.

In a control system with the control circuit 110 as its core, if character data, for example, is input through the PC 118, the text, that is, document data is sequentially stored in the text memory 117A, and the print head 23 is driven through the driving circuit 120. As a result, each heater element is selectively heated and driven in response to a print dot for one line so as to print the dot pattern data stored in the print buffer 117B. Then, the feeding motor 119 carries out feeding control of the tape through the driving circuit 121 in synchronization with the printing. Also, the transmission circuit 306 carries out modulation control of the carrier wave on the basis of the control signal from the control circuit 110 so as to output an interrogation wave. Then, the receiving circuit 307 carries out processing of a signal demodulated on the basis of the control signal from the control circuit 110.

A configuration of the antenna unit ANT2 for information acquisition is described by using FIG. 8.

In FIG. 8, the antenna unit ANT2 for information acquisition includes the magnetic-field radiation antenna 400, the electric-field radiation antenna 500, a matching circuit 450 for magnetic-field radiation antenna connected to the magnetic-field radiation antenna 400, a matching circuit 550 for electric-field radiation antenna connected to the electric-field radiation antenna 500, and a connection switch 93. The matching circuit 450 for magnetic-field radiation antenna and the matching circuit 550 for electric-field radiation antenna both constitute matching devices. The connection switch 93 constitutes a selection connecting device and selectively connects either of the matching circuit 450 for magnetic-field radiation antenna and the matching circuit 550 for electric-field radiation antenna to the switching circuit 86.

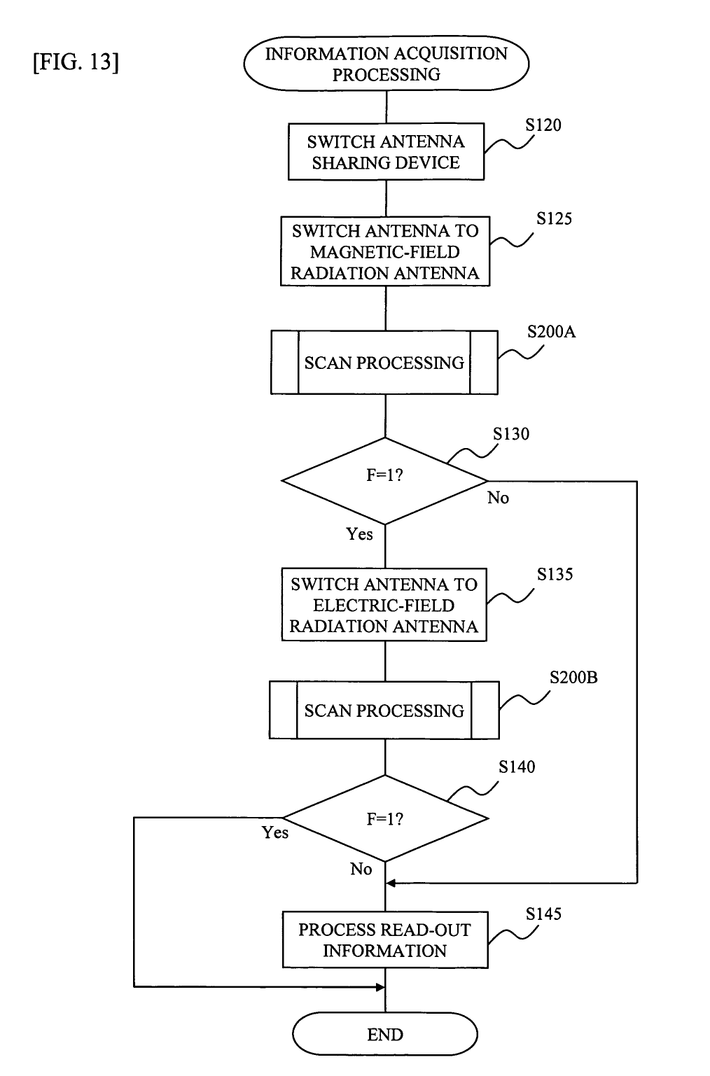

The connection switch 93 carries out, as will be described in detail using FIG. 13, which will be described later, a switching operation on the basis of a control signal input from the control circuit 110 through the input/output interface 113. That is, the connection switch 93 selectively connects either of the matching circuit 450 for magnetic-field radiation antenna or in other words, the magnetic-field radiation antenna 400 and the matching circuit 550 for electric-field radiation antenna or in other words, the electric-field radiation antenna 500 to the switching circuit 86.

The magnetic-field radiation antenna 400 is constructed by a small-sized micro loop antenna having a substantially square shape, that is, a small-sized loop antenna in this example. A length of the entire periphery of the magnetic-field radiation antenna 400 is set to a half wavelength corresponding to a frequency of the carrier wave of a radio communication wave in use, that is, a dimension slightly shorter than ½ of the wavelength λ. Specifically, suppose that the frequency of the communication wave to be used is 915 MHz in the UHF band, for example. In this case, the length of one side of a square of the magnetic-field radiation antenna 400 is set to approximately 4 cm so that the length of the entire periphery of the square of the magnetic-field radiation antenna 400 becomes approximately 16 cm, which is a half of the 1 wavelength λ (≅32 cm) of 915 MHz. In this way, the micro loop antenna formed with the entire length slightly shorter than the half wavelength of the frequency in use generates a communicable area in a relatively short distance and carries out radio communication in an electromagnetic induction method. As a result, the micro loop antenna has a characteristic that external noise is hard to be received.

The electric-field radiation antenna 500 is constructed by a linear-shaped dipole antenna in which a feeding point P is disposed at the center in this example. The entire length of the electric-field radiation antenna 500 is set, if the communication wave is the frequency 915 MHz along with the above example, to approximately 16 cm, which is the half wavelength. This dipole antenna generates a communicable area in relatively long distance and carries out radio communication in an electric wave method. In FIG. 8, priority is given to clear depiction of the shapes of the antennas 400, 500, and dimensional ratios of parts are not accurately illustrated. The dimensional ratios are not accurate not only in FIG. 8 but in other figures.

In the communicable area of the magnetic-field radiation antenna 400, a distance from the antenna 400 to the farthest position is ½π times of the wavelength λ of the used frequency, that is, a distance slightly longer than λ/2π≅5.2 cm in the example of 915 MHz. With the magnetic-field radiation antenna 400, radio communication becomes difficult at a position where the distance from the magnetic-field radiation antenna 400 is larger than approximately 5.2 cm. On the other hand, the magnetic-field radiation antenna 400 can carry out radio communication favorably with the RFID tag circuit element To for information acquisition located at a position where the distance from the magnetic-field radiation antenna 400 is smaller than approximately 5.2 cm. On the contrary, in the communicable area the electric-field radiation antenna 500 can generate, a distance from the antenna 500 to the closest position is a distance slightly smaller than ½π times of the wavelength λ of the same used frequency, that is, a distance slightly smaller than λ/2π≅5.2 cm in the example of 915 MHz. With the electric-field radiation antenna 500, radio communication becomes difficult at a position where the distance from the electric-field radiation antenna 500 is smaller than approximately 5.2 cm. On the other hand, the electric-field radiation antenna 500 can carry out radio communication favorably with the RFID tag circuit element To for information acquisition located at a position where the distance from the electric-field radiation antenna 500 is larger than approximately 5.2 cm.

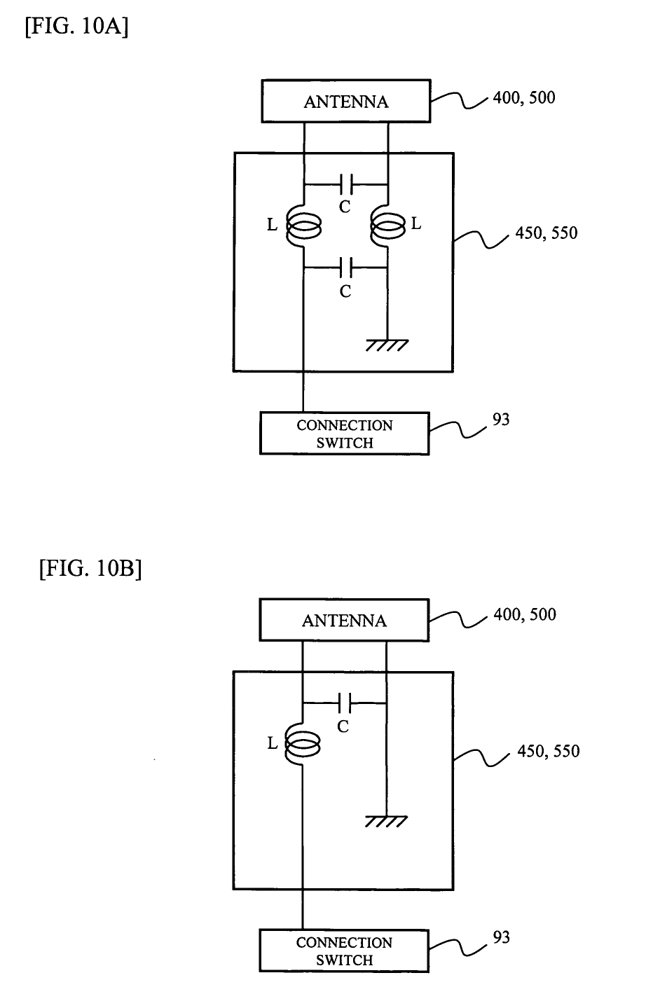

The matching circuit 450 for magnetic-field radiation antenna carries out impedance matching when the antenna 400 is connected to the transmission circuit 306 or the receiving circuit 307 through the connection switch 93, the switching circuit 86, and the antenna sharing device 240. That is, the matching circuit 450 for magnetic-field radiation antenna suppresses transmission loss of energy at the antenna 400 and a connection line of a path to the antenna 400, that is, a feeding line. Similarly, the matching circuit 550 for electric-field radiation antenna carries out impedance matching when the antenna 500 is connected to the transmission circuit 306 or the receiving circuit 307 through the connection switch 93, the switching circuit 86, and the antenna sharing device 240. That is, the matching circuit 550 for electric-field radiation antenna suppresses transmission loss of energy at the antenna 500 and a connection line of a path to the antenna 500, that is, a feeding line. Note that the matching circuits 450, 550 may use, for example, any of a matching circuit by a lumped constant in which a coil and a capacitor are combined, a matching circuit by a distributed constant, and a matching circuit by a combination of the lumped constant and the distributed constant (See FIGS. 10A and 10B, which will be described later).

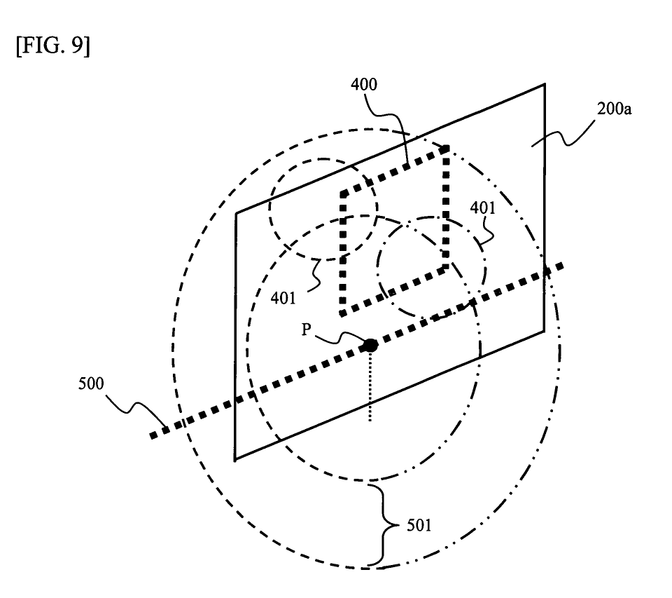

As shown in FIG. 9, the magnetic-field radiation antenna 400, which is a micro loop antenna, is installed inside the housing 200. In this example, the magnetic-field radiation antenna 400 is installed in a layout opposing and in parallel with the side wall face 200a. At the center on both front and back sides of this magnetic-field radiation antenna 400, for example, substantially spherical communicable areas 401 are generated. That is, one communicable area 401 expressed by a one-dot chain line portion in the figure passes through the side wall face 200a and is generated on the front face side, that is, the right front side in the figure.

The electric-field radiation antenna 500, which is a dipole antenna, is installed on substantially the same plane as the magnetic-field radiation antenna 400 and is arranged in parallel with one side of the magnetic-field radiation antenna 400. Around the feeding point P at the center of this electric-field radiation antenna 500, for example, an annular communicable area 501 having the linear-shaped antenna as its center axis is generated. A substantially half of the communicable area 501 expressed by a two-dot chain line portion in the figure, that is, a half ring portion is generated outside the housing 200.

The magnetic-field radiation antenna 400 and the electric-field radiation antenna 500 are arranged at locations close to each other. As a result, particularly directions of main lobes of the two antennas 400, 500 are overlapped. Also, as described above, the generation distances of the communicable areas 401, 501 from respective antennas 400, 500 are different, and the magnetic-field radiation antenna 400 generates the communicable area 401 in a short distance, while the electric-field radiation antenna 500 generates the communicable area 501 in a long distance. The two communicable areas 401, 501 are partially overlapped at a position separated from the side wall face 200a by a distance of λ/2π or approximately 5 cm in the case of the above-described 915 MHz. Alternatively, characteristics, layout configurations or communication frequency to be used, for example, of respective antennas 400, 500 may be adjusted so that the two communicable areas 401, 501 are partially overlapped.

In the above positional relation, the communicable areas 401, 501 of respective antennas 400, 500 are generated. As a result, an area within approximately 5 cm outward from the front face of the side wall face 200a, that is, the center on the surface on the right front side in the figure becomes the communicable area 401 of the magnetic-field radiation antenna 400. Also, an area outside the area within approximately 5 cm outward becomes the communicable area 501 of the electric-field radiation antenna 500. As a result, in a direction on the surface side of the side wall face 200a, the communicable areas 401, 501 of respective antennas 400, 500 are continuously arranged together. In the apparatus 1 for communicating with an RFID tag, the shield member 85 made of metal, for example, for shielding a generated magnetic flux is disposed between the loop antenna ANT1 for label production and the antenna unit ANT2 for information acquisition. Therefore, radiation of an electromagnetic field does not actually occur on the side of the loop antenna ANT1 for label production.

As shown in FIG. 10A, in the matching circuits 450, 550 in this example, coils L are connected in series to both of the feeding line and ground line for the antennas 400, 500, respectively. The feeding line and the ground line are shown as a single line in FIG. 8 for simplification. A capacitor C is connected between connection points on the side of the antennas 400, 500 of each coil L. The capacitor C is also connected between the side of the connection switch 93 of one of the coils L on the left side in the figure and the ground side of the other coil L on the right side in the figure.

As shown in FIG. 10B, in the matching circuits 450, 550 in this example, the coil L is connected in series only to the feeding line for the antennas 400, 500. The capacitor C is connected between the connection point and the ground line on the side of the antennas 400, 500 of the coil L, which constitutes a so-called L-shaped matching circuit.

The matching circuits 450, 550 may use, for example, T-type, II-type, induction coupling type, and combinations of them, not particularly shown, other than the above.

In the apparatus 1 for communicating with an RFID tag having the basic configuration as above, as described above, the label production processing mode and the information acquisition processing mode can be carried out. The label production processing mode is a mode for producing an RFID label T using the RFID tag circuit element To for label production in the housing 200. That is, in the label production processing mode, the base tape 101 provided with the RFID tag circuit element To for label production is fed by the feeding roller 27, and information transmission and reception is conducted with respect to the RFID tag circuit element To for label production through the loop antenna ANT1 for label production so as to produce the RFID label T. On the other hand, the information acquisition processing mode is a mode for information reading, that is, information acquisition, from the RFID tag circuit element To for information acquisition outside the apparatus 1. That is, in the information acquisition processing mode, the information transmission and reception is conducted with the RFID tag circuit element To for information acquisition located outside the housing 200 through the antenna unit ANT2 for information acquisition, by which predetermined RFID tag information is read and obtained.

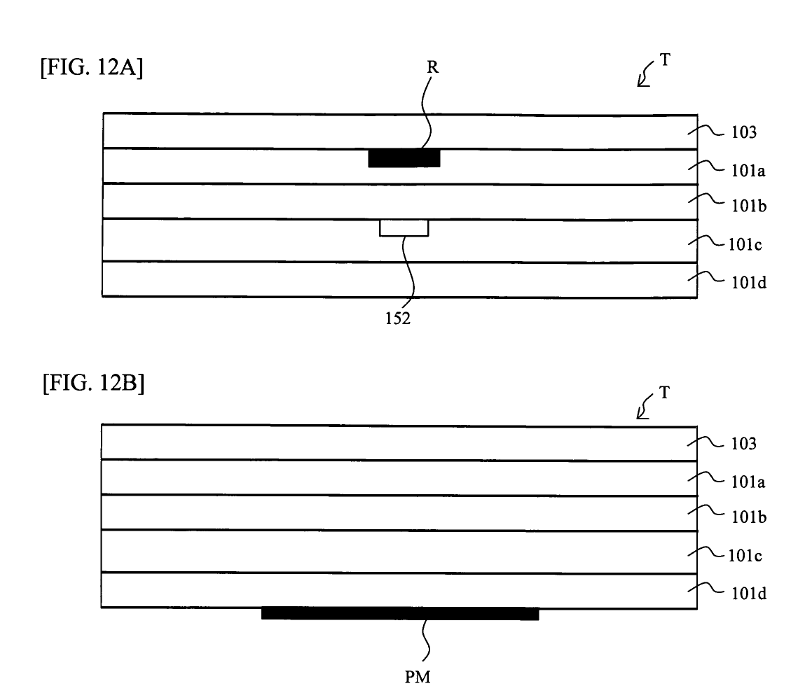

The RFID label T formed in the above-described label production mode is described by using FIG. 11A, FIG. 11B, FIG. 12A, and FIG. 12B. The RFID label T is produced by completing information writing or reading of the RFID tag circuit element To for label production and cutting of the tag label tape 109 with print.

As shown in FIGS. 11A, 11B, 12A and 12B, the RFID label T is in the five-layered structure in which the cover film 103 is added to the four-layered structure shown in FIG. 5 as described above. That is, the RFID label T includes five layers with the cover film 103, the adhesive layer 101a, the base film 101b, the adhesive layer 101c, and the separation sheet 101d from the side of the cover film 103, that is, the upper side in FIGS. 12A and 12B to the opposite side, that is, lower side in FIGS. 12A and 12B. The RFID tag circuit element To for label production including the tag antenna 152 disposed on the back side of the base film 101b as described above is provided in the base film 101b and the adhesive layer 101c. Also, a label print character string R or character string of “RF-ID” indicating a type of the RFID label T in this example corresponding to stored information, for example, of the RFID tag circuit element To for label production is printed on the back face of the cover film 103.

On the cover film 103, the adhesive layer 101a, the base film 101b, and the adhesive layer 101c, a half-cut line HC is formed by the half cutter 34 substantially along the tape width direction as described above. The half-cut line HC corresponds to a half-cut portion and includes two lines of a front half-cut line HC1 and a rear half-cut line HC2 in this example. An area held between the half-cut lines HC1, HC2 in the cover film 103 becomes a print area S on which the label print character string R is to be printed. In the cover film 103, areas on both sides in the tape longitudinal direction having the half-cut lines HC1, HC2 between them from the print area S are a front margin area S1 and a rear margin area S2.

In the above, the most distinctive characteristic of this embodiment is, in the information acquisition processing mode, an antenna switching mode when information transmission and reception with respect to the RFID tag circuit element To for information acquisition located outside the housing 200 is conducted. That is, switching of the connection switch 93 in the antenna unit ANT2 for information acquisition is carried out. Then, communication is executed after the switching is made between the short distance communication through the magnetic-field radiation antenna 400 and the long distance communication through the electric-field radiation antenna 500. The details will be sequentially described below.

A detailed procedure executed by the CPU 111 of the control circuit 110 in the information acquisition processing mode is described by using FIG. 13.

In FIG. 13, first, at Step S120, the CPU 111 transmits a control signal to the switching circuit 86 and connects the antenna sharing device 240 to the antenna unit ANT2 for information acquisition. After that, the routine goes to Step S125.

At Step S125, the CPU 111 transmits a control signal to the connection switch 93 of the antenna unit ANT2 for information acquisition and connects the switching circuit 86 to the matching circuit 450 for magnetic-field radiation antenna. As a result, the magnetic-field radiation antenna 400 is connected to the transmission circuit 306 or the receiving circuit 307 through the matching circuit 450, the connection switch 93, and the antenna sharing device 240.

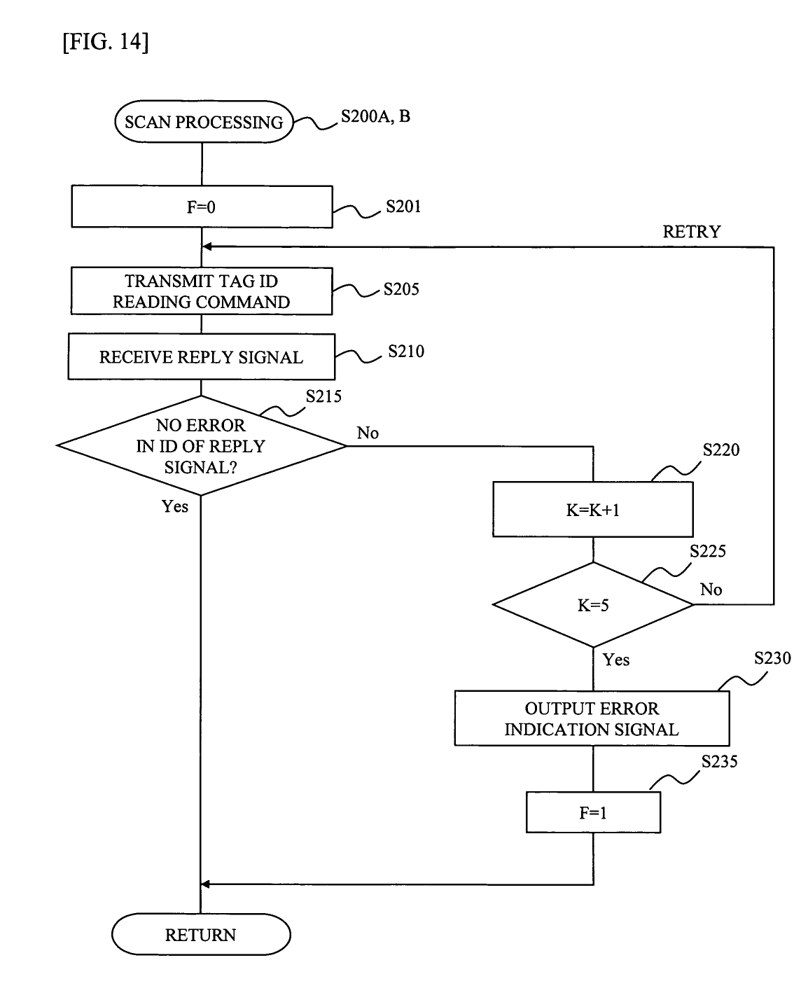

After that, the routine goes to Step S200A, and scanning processing is carried out by the short distance communication through the magnetic-field radiation antenna 400 (See FIG. 14, which will be described later). This scanning processing reads information including a tag ID stored in the IC circuit part 151 of the RFID tag circuit element To for information acquisition at a predetermined communication frequency. When the scanning processing at Step S200A is completed, the routine goes to Step S130.

At Step S130, the CPU 111 determines if a flag F (which will be described later) indicating if there has been a communication error or not is one or not. In other words, the CPU 111 determines if the scanning processing at Step S200A carried out in the short distance communication has read or not a reply signal including predetermined information from the RFID tag circuit element To for information acquisition. If some reply signal has been read, it remains at F=0 (See FIG. 14, which will be described later), and the determination is not satisfied, and the routine goes to Step S145, which will be described later. If no reply signal has been read, it is F=1 (See FIG. 14, which will be described later), and the determination is not satisfied, and the routine goes to Step 135.

At Step S135, the CPU 111 transmits a control signal to the connection switch 93 of the antenna unit ANT2 for information acquisition and connects the switching circuit 86 to the matching circuit 550 for electric-field radiation antenna. As a result, the electric-field radiation antenna 500 is connected to the transmission circuit 306 or the receiving circuit 307 through the matching circuit 550, the connection switch 93, and the antenna sharing device 240.

After that, the routine goes to Step S200B, and the scanning processing is carried out by the long distance communication through the electric-field radiation antenna 500 (See FIG. 14, which will be described later). This scanning processing reads information including a tag ID stored in the IC circuit part 151 of the RFID tag circuit element To for information acquisition at substantially the same communication frequency as that at Step S200A. When the scanning processing at Step S200B is completed, the routine goes to Step S140.

At Step S140, the CPU 111 determines if the above flag F=1 or not again. In other words, the CPU 111 determines if the scanning processing at Step S200B carried out in the long distance communication has read or not a reply signal including predetermined information from the RFID tag circuit element To for information acquisition. If some reply signal has been read, it remains at F=0 (See FIG. 14, which will be described later), and the determination is not satisfied, and the routine goes to Step S145, which will be described later. If no reply signal has been read, it is F=1 (See FIG. 14, which will be described later), and the determination is not satisfied, and this flow is finished.

At Step S145, the CPU 111 processes the RFID tag information obtained from the RFID tag circuit element To for information acquisition as appropriate on the basis of the reply signal received at Step S200A or Step S200B. In this processing, the CPU 111 outputs the RFID tag information through the input/output interface 113 and the communication line NW, for example, and stores it in the information server IS or the route server RS as necessary so that it can be referred to by the PC 118, for example. Alternatively, the CPU 111 may display the RFID tag information by a display device of the PC 118. Then, this flow is finished.

A detailed procedure of Step S200A or Step S200B in FIG. 13 is described by using FIG. 14.

In FIG. 14, first, at Step S201, the CPU 111 initializes the flag F indicating if there has been a communication error or not to zero.

After that, at Step S205, predetermined modulation is applied to an interrogation wave by control of the CPU 111, and an inquiry signal or a tag ID reading command signal in this example, is generated in order to acquire the tag ID stored in the RFID tag circuit element To. The generated tag ID reading command signal is transmitted to the RFID tag circuit element To for information acquisition as a reading target through the antenna of the antenna unit ANT2 for information acquisition, and a reply is prompted. In the case of Step S200A, the magnetic-field radiation antenna 400 is used, while in the case of Step S200B, the electric-field radiation antenna 500 is used.

At Step S210, the CPU 111 takes in the reply signal including the RFID tag information such as the tag ID transmitted from the RFID tag circuit element To for information acquisition as a reading target in response to the inquiry signal through the antenna of the antenna unit ANT2 for information acquisition and the receiving circuit 307. At this time, in the case of Step S200A, the reply signal is received through the magnetic-field radiation antenna 400, while in the case of Step S200B, the reply signal is received through the electric-field radiation antenna 500.

Then, at Step S215, the CPU 111 determines if there is no error in the received reply signal or not using a known error detection code such as a Cyclic Redundancy Check (CRC code).

If the determination is not satisfied, the routine goes to Step S220, where the CPU 111 adds one to a variable K. The variable K is a variable for counting the number of retry times at communication failure and is initialized to zero at first. After that, at Step S225, the CPU 111 determines if the variable K has reached a predetermined retry number of times set in advance or not. In this example, the retry number of times is set to five times, but it may be set at number of times other than that as appropriate. In the case of K<4, the determination is not satisfied and the routine returns to Step S205, where the similar procedure is repeated. In the case of K=5, the routine goes to Step S230, where the CPU 111 outputs an error display signal through the input/output interface 113 so as to display an error display indicating reading failure. After that, the CPU 111 sets the flag F=1 indicating presence of a communication error at Step S235, and this flow is finished.

In this way, even if information reading is not successful, retry is made up to the predetermined number of times or five times in this example. If reading failure reaches five times, it becomes the flag F=1, and the determination at Step S130, Step S140 in FIG. 13 is satisfied.

On the other hand, if the determination at Step S215 is satisfied, the RFID tag information reading from the RFID tag circuit element To for information acquisition as a reading target is completed, and this flow is finished.

In the above, the procedures at Step S125 and Step S135 in the flow in FIG. 13 constitute a control portion.

In this embodiment configured as above, the magnetic-field radiation antenna 400 suitable for the short distance communication and the electric-field radiation antenna 500 suitable for the long distance communication are provided. Moreover, either of the antennas 400, 500 is selectively connected by the connection switch 93 to the transmission circuit 306. Then, in the information acquisition processing mode, communication with the RFID tag circuit element To for information acquisition is started. At this time, even if the distance to the RFID tag circuit element To for information acquisition is short, the scanning processing by the magnetic-field radiation antenna 400 at Step S200A obtains information. Even if the distance to the RFID tag circuit element To for information acquisition is large, the scanning processing by the electric-field radiation antenna 500 at Step S200B obtains information. That is, the communication is switched automatically and tried automatically. As a result, even if an operator does not worry about the distance to the communication target, easy and optimal communication is executed, and information is obtained. As a result, an operation burden on the operator can be reduced.

Also, particularly in this embodiment, a micro loop antenna, which is a small-sized loop antenna, is used as the magnetic-field radiation antenna 400. As a result, the information transmission and reception with a communication target in a short distance is efficiently executed mainly by electromagnetic coupling or electromagnetic induction. Note that, the electric-field radiation antenna 500 may be a loop antenna, which is not small-sized and provided with a peripheral length substantially equal to the wavelength of the communication wave or a micro strip antenna, that is, a patch antenna, other than the configuration of the dipole antenna as in the above embodiment.

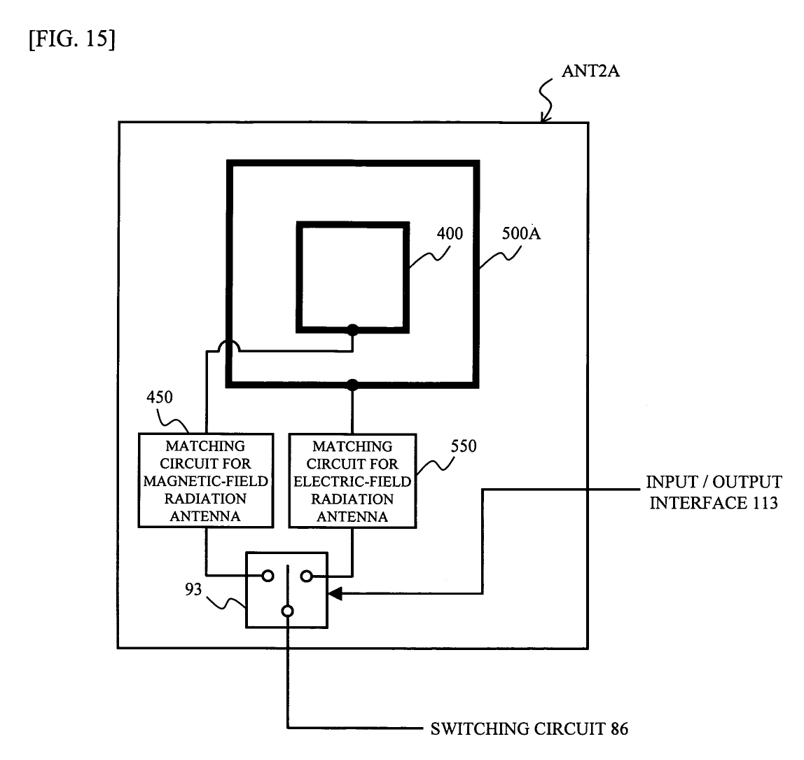

A configuration of an antenna unit ANT2A for information acquisition when a loop antenna is used as the electric-field radiation antenna is described by using FIG. 15. FIG. 15 is a diagram corresponding to FIG. 8. The same reference numerals are given to the portions equivalent to the configuration of the antenna unit ANT2 for information acquisition (See FIG. 8) in the above embodiment, and description is omitted or simplified as appropriate. The same applies to the drawings below.

In FIG. 15, an electric-field radiation antenna 500A is constructed by a relatively large-sized loop antenna having a substantially square shape. The peripheral length of the electric-field radiation antenna 500A is equal to 1 wavelength λ of the communication wave, that is, approximately 32 cm when the frequency of the communication wave is 915 MHz, for example. As a result, the length of one side of the electric-field radiation antenna 500A is set to approximately 8 cm. The large-sized loop antenna when the entire peripheral length is formed at the same length as the wavelength of the used frequency is capable of radio communication in a long distance by the electric wave method.

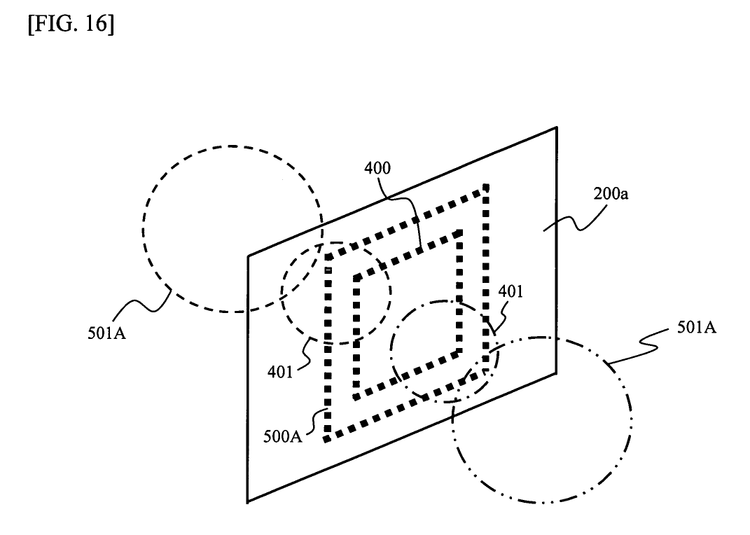

As shown in FIG. 16, the large-sized loop-antenna type electric-field radiation antenna 500A is arranged substantially on the same plane as the micro loop-antenna type magnetic-field radiation antenna 400. A center point in a radial direction of the electric-field radiation antenna 500A and a center point in the radial direction of the micro loop-antenna type magnetic-field radiation antenna 400 are substantially matched with each other. Similarly to the above-described dipole antenna type electric-field radiation antenna 500 shown in FIG. 9, a substantially spherical communicable area 501A, for example, is generated. The communicable areas 501A are generated from the center on the both front and rear sides of the electric-field radiation antenna 500A toward a direction separated from a position separated by approximately 5 cm in the above-described example of 915 MHz.

The communicable areas 401, 501A of the antennas 400, 500 with the above positional relation are partially overlapped at the position separated by approximately 5 cm from the antenna unit ANT2A for information acquisition. That is, the directions of main lobes of the two antennas 400, 500A are overlapped. As above, even if the antenna unit ANT2A for information acquisition in which the magnetic-field radiation antenna 400, which is a micro loop-antenna type, and the electric-field radiation antenna 500A, which is a large-sized loop antenna, are combined is used, the effect similar to that of the above embodiment can be obtained.

The shapes of the micro loop antenna and the large-sized loop antenna are not limited to square shape. The micro loop antenna and the large-sized loop antenna may have a circular shape including an oval or other polygonal shapes, for example. Also, the micro loop antenna and the large-sized loop antenna may be in a plurally wound coil shape as long as the length of the entire length is the same. The frequency of the used communication wave is not limited to 915 MHz in the above UHF band (860 to 960 MHz), either. As the frequency of the used communication wave, 13.56 MHz (λ≅22 m), which is a short wave band, or 2.45 GHz (λ≅12 cm), which is a micro wave band, may be used, for example. In that case, dimensions of each part of the antennas 400, 500, 500A are set according to the wavelength of the frequency.

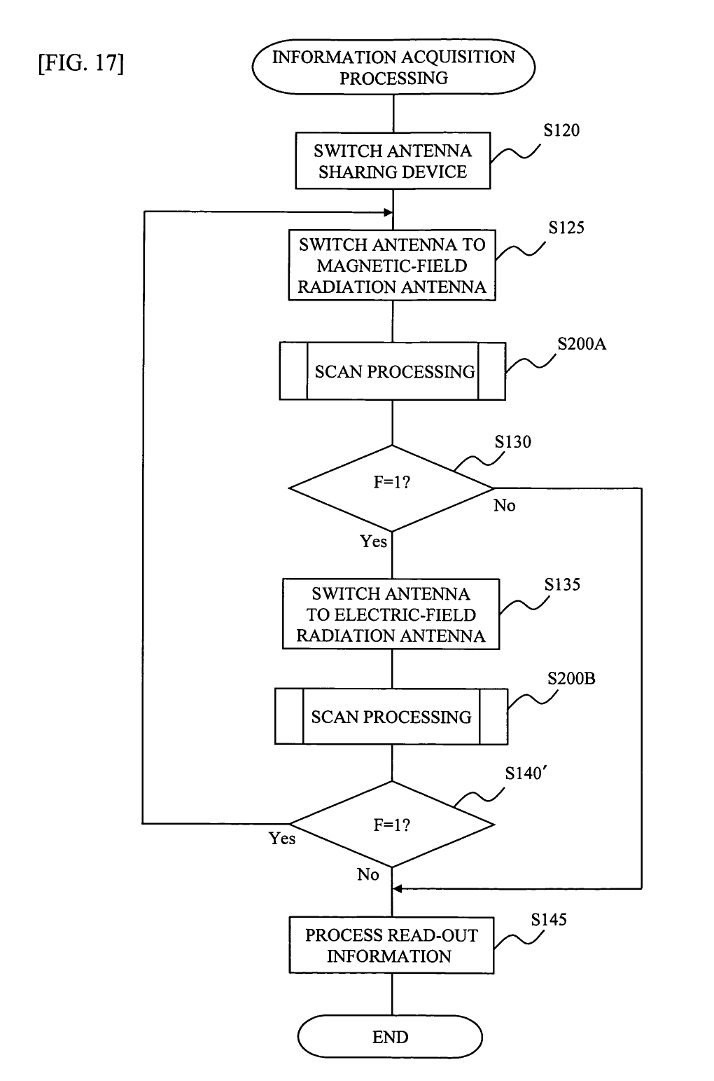

Note that the information transmission and reception by the short distance communication through the magnetic-field radiation antenna 400 and the long distance communication through the electric-field radiation antenna 500 may be repeated alternately till a predetermined communication result is obtained. A detailed procedure relating to the information acquisition processing when the short distance communication and the long distance communication are repeated alternately is described by using FIG. 17.

In the flow of FIG. 17, a point different from the flow in FIG. 13 is that Step S140′ is provided instead of Step S140. That is, if the scanning processing at Step S200B is finished and it is F=1 at the subsequent Step S140′, that is, a communication error has occurred, the routine returns to Step S125. At Step S125, the CPU 111 switches the switching circuit 86 to the side of the magnetic-field radiation antenna 400 again and repeats the scanning processing. For the other procedures, they are the same as those in FIG. 13, and description will be omitted.

In the above, the procedures at Step S125 and Step S135 constitute the control portion.

Until the predetermined communication result is obtained, communication is conducted using the magnetic-field radiation antenna 400 and the electric-field radiation antenna 500 alternately as above. As a result, the optimal communication can be easily conducted.

Also, particularly in this embodiment, the matching circuits 450, 550 corresponding to the magnetic-field radiation antenna 400 and the electric-field radiation antenna 500 are disposed, respectively. When the magnetic-field radiation antenna 400 or the electric-field radiation antenna 500 is selectively connected to the transmission circuit 306, impedance on the side of each of the antennas 400, 500 is matched with that on the side of the transmission circuit 306. As a result, even if either of the magnetic-field radiation antenna 400 and the electric-field radiation antenna 500 is connected to the side of the transmission circuit 306, impedance on the side of the antennas 400, 500 and that on the side of the transmission circuit 306 can be matched with each other. As a result, power can be efficiently generated, and smooth communication can be conducted.

Also, particularly in this embodiment, the magnetic-field radiation antenna 400 and the electric-field radiation antenna 500 are arranged so that the main lobe directions thereof are overlapped with each other. As a result, whether the single RFID tag circuit element To for information acquisition located in a certain direction is at a short distance or a long distance from the antenna, communication can be reliably conducted by the magnetic-field radiation antenna 400 or the electric-field radiation antenna 500.

Also, particularly in this embodiment, the magnetic-field radiation antenna 400 and the electric-field radiation antenna 500 are arranged so that the areas 401, 501 capable of communication are partially overlapped with each other. As a result, whether the single RFID tag circuit element To for information acquisition located is at a short distance or a long distance from the antenna, communication can be reliably conducted without exception by the magnetic-field radiation antenna 400 or the electric-field radiation antenna 500.

Also, particularly in this embodiment, at least one of the magnetic-field radiation antenna 400 and the electric-field radiation antenna 500 is configured to be common to transmission and reception. Also, particularly in the present embodiment, these functions are common to both types. As a result, simplification of the circuit configuration and reduction of the number of components can be promoted as compared with a case using separate antennas for transmission and reception.

It should be noted that the present invention is not limited to the above embodiments but capable of various variations in a range not departing from a gist and technical idea. Such variations will be sequentially described below.

(1) When the configuration of the magnetic-field radiation antenna and that of the electric-field radiation antenna are partially made common and exclusive matching circuits are connected to each antenna, respectively:

In the above embodiment, the magnetic-field radiation antenna 400 and the electric-field radiation antenna 500 are disposed independently from each other. However, the present invention is not limited to such a configuration. In this variation, the configuration of the magnetic-field radiation antenna 400 and that of the electric-field radiation antenna 500 are partially made common. Moreover, it is so configured that the exclusive matching circuits 450, 550 are switched and connected to each of the magnetic-field radiation antenna 400 and the electric-field radiation antenna 500.

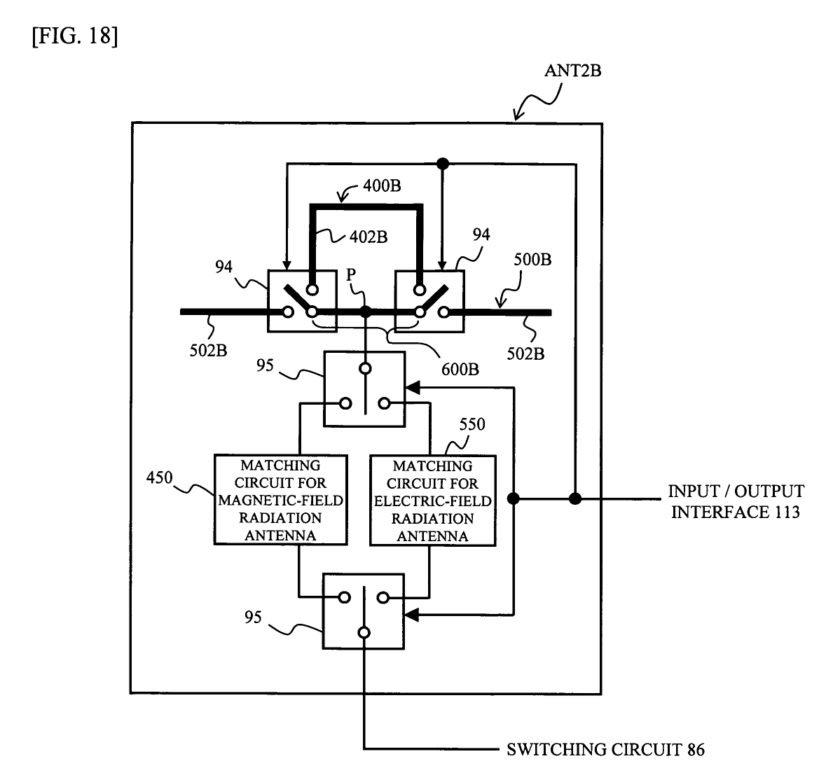

A configuration of an antenna unit ANT2B for information acquisition in this variation is described by using FIG. 18.

In FIG. 18, the antenna unit ANT2B for information acquisition has a magnetic-field radiation antenna 400B, which is a micro loop antenna, and an electric-field radiation antenna 500B, which is a dipole antenna.

At this time, one side of the substantially square-shaped magnetic-field radiation antenna 400B, that is, a lower side in FIG. 18, and a center portion of the linear-shaped electric-field radiation antenna 500B are configured to be a common portion. At the center position of a common antenna element portion 600B, which is the common portion, a feeding point P shared by the respective antennas 400B, 500B is disposed. The common antenna element portion constitutes a first common antenna element portion. At both ends of the common antenna element portion 600B, antenna connection switches 94 are disposed, respectively. The antenna connection switch 94 constitutes a selection connecting device. The two antenna connection switches 94, 94 are switched on the basis of a control signal from the control circuit 110 through the input/output interface 113 in conjunction with each other. That is, the antenna connection switches 94, 94 selectively connect each end portion of the common antenna element portion 600B to each end portion of an exclusive portion 402B of the magnetic-field radiation antenna 400B or each end portion of an exclusive portion 502B of the electric-field radiation antenna 500B. The exclusive portion 402B of the magnetic-field radiation antenna 400B corresponds to a portion excluding the common antenna element portion 600B from the entire magnetic-field radiation antenna 400B, which is a micro loop antenna. The exclusive portion 502B of the electric-field radiation antenna 500B corresponds to both side portions excluding the common antenna element portion 600B from the entire electric-field radiation antenna 500B, which is a dipole antenna.

Also, in the antenna unit ANT2B for information acquisition of this variation, two circuit connection switches 95, 95 are connected between the feeding point P and the switching circuit 86 (See FIG. 7). The circuit connection switch 95 corresponds to a selection connecting device. The circuit connection switches 95, 95 are switched in conjunction with each other on the basis of the control signal from the control circuit 110. That is, the circuit connection switches 95, 95 selectively connect the feeding point P and the switching circuit 86 to the matching circuit 450 for magnetic-field radiation antenna or the matching circuit 550 for electric-field radiation antenna.

In the above configuration, each of the antenna connection switches 94, 94 is switched to the upper side in the figure, and the common antenna element portion 600B is connected to the exclusive portion 402B of the magnetic-field radiation antenna 400B. Moreover, each of the circuit connection switches 95, 95 is switched to the left side in the figure, and the feeding point P and the switching circuit 86 is connected to the matching circuit 450 for magnetic-field radiation antenna. As a result, the common antenna element portion 600B and the exclusive portion 402B constitute the magnetic-field radiation antenna 400B, which is a micro loop antenna, and thereby the antenna unit ANT2B for information acquisition is capable of radio communication in a short distance.

Also, each antenna connection switch 94 is switched to the lower side in the figure, and the common antenna element portion 600B is connected to the exclusive portion 502B of the electric-field radiation antenna 500B. Moreover, each of the circuit connection switches 95, 95 is switched to the right side in the figure, and the feeding point P and the switching circuit 86 are connected to the matching circuit 550 for electric-field radiation antenna. As a result, the common antenna element portion 600B and the exclusive portion 602B constitute the electric-field radiation antenna 500B, which is a dipole antenna, and thereby the antenna unit ANT2B for information acquisition is capable of radio communication in a long distance.

With the variation configured as above, the effect similar to the above embodiment can be obtained. Moreover, the magnetic-field radiation antenna 400B and the electric-field radiation antenna 500B share the common antenna element portion 600B, and simplification of the circuit configuration around the antenna and reduction of the antenna installation space can be promoted.

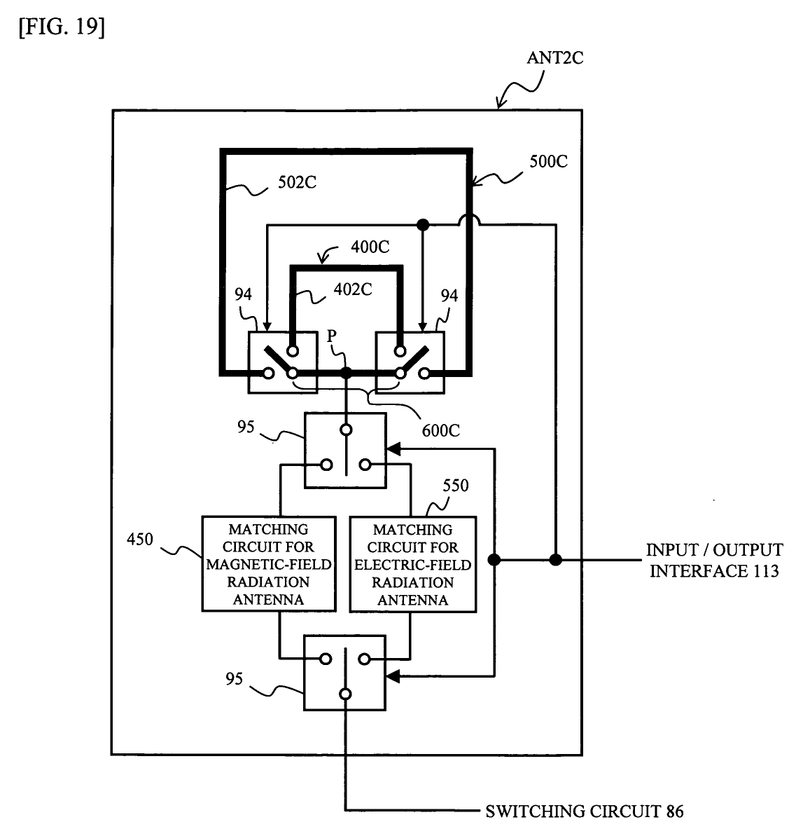

In this variation, too, the large-sized loop antenna (See FIG. 15) can be applied instead of the dipole antenna as the electric-field radiation antenna. In this case, as shown in FIG. 19, one side of a magnetic-field radiation antenna 400C, which is a micro loop antenna, that is, the lower side in the figure and one side of an electric-field radiation antenna 500C, which is a large-sized loop antenna, that is, a part of the lower side in the figure are shared as a common antenna element portion 600C. At both ends of the common antenna element portion 600C, the antenna connection switches 94 are disposed, and the feeding point P is disposed at a part of the common antenna element portion 600C. In this case, by disposing the magnetic-field radiation antenna 400C inside the electric-field radiation antenna 500C as shown in the figure, main lobe directions of the antennas 400C, 500C are made to overlap each other.

(2) When the configuration of the magnetic-field radiation antenna and that of the electric-field radiation antenna are partially made common and the matching circuit to be connected is also made common:

That is, a part of the configuration of the magnetic-field radiation antenna and a part of the configuration of the electric-field radiation antenna are made common, and moreover, the matching circuit to be connected is also made common into one.

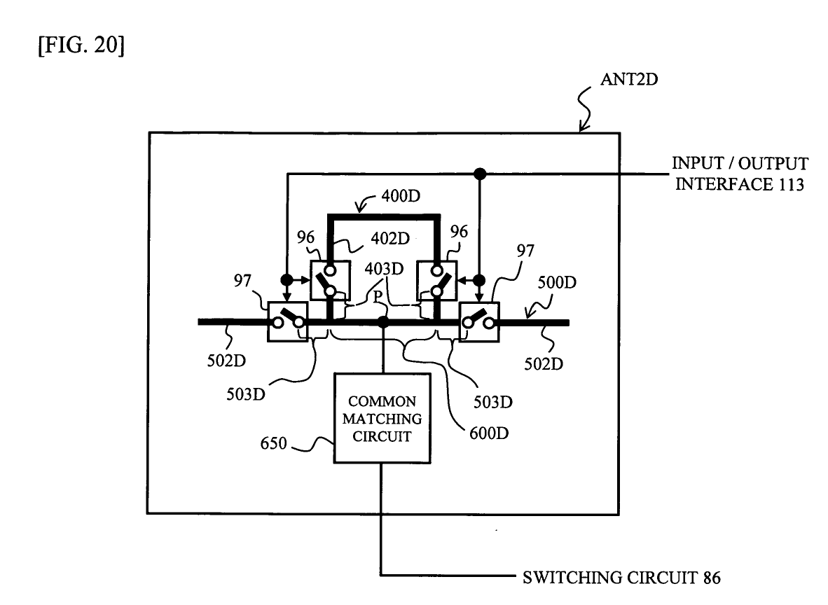

A configuration of an antenna unit ANT2D for information acquisition of this variation is described by using FIG. 20.

In FIG. 20, in the antenna unit ANT2D for information acquisition, similarly to FIG. 18, one side of a substantially square-shaped magnetic-field radiation antenna 400D and a center portion of a linear-shaped electric-field radiation antenna 500D are made common. At the center position of a common antenna element portion 600D, which is the common portion, the feeding point P shared by the antennas 400D, 500D is disposed. The common antenna element portion 600D corresponds to a second common antenna element portion. At both ends of the common antenna element portion 600D, a stub 403D in loop and a stub 503D in dipole are formed. The stub 403D in loop extends toward each end portion of exclusive portions 402D of the magnetic-field radiation antenna 400D and it corresponds to a first antenna element for stub and also corresponds to a matching device. The stub 503D in dipole extends toward each end portion of exclusive portions 502D of the electric-field radiation antenna 500D, and it corresponds to a second antenna element for stub and also corresponds to the matching device.

Also, at the tip end of the stub 403D in loop, a loop antenna connection switch 96 is disposed functioning as a selection connecting device. The loop antenna connection switch 96 switches connection and disconnection between the distal end of the stub 403D in loop and each end portion of the exclusive portion 402D of the magnetic-field radiation antenna 400D on the basis of a control signal from the control circuit 110 through the input/output interface 113. At the distal end of the stub 503D in dipole, a dipole antenna connection switch 97 functioning as a selection connecting device is disposed. The dipole antenna connection switch 97 switches connection and disconnection between the distal end of the stub 503D in dipole and each end portion of the exclusive portion 502D of the electric-field radiation antenna 500D on the basis of the control signal from the control circuit 110 through the input/output interface 113.

Also, in the antenna unit ANT2D for information acquisition of this variation, only one common matching circuit 650 is disposed. The common matching circuit 650 functions as a matching device and is connected to the feeding point P and the switching circuit 86.

In the above configuration, each loop antenna connection switch 96 is switched to the upper side in the figure, the stub 403D in loop and the exclusive portion 402D of the magnetic-field radiation antenna 400D are connected. Moreover, each dipole antenna connection switch 97 is switched to the upper side in the figure, and the stub 503D in dipole and the exclusive portion 502D of the electric-field radiation antenna 500D are disconnected. As a result, the common antenna element portion 600D, the two stubs 403D in loop, and the two exclusive portions 402D constitute the magnetic-field radiation antenna 400D, which is a micro loop antenna. As a result, the antenna unit ANT2D for information acquisition can conduct radio communication in a range of a short distance from the antenna. At this time, the two stubs 503D in dipole become extra branch lines for the magnetic-field radiation antenna 400D and function as so-called stubs capable of matching impedance. That is, by setting the length of the two stubs 503D in dipole as appropriate, impedance of the magnetic-field radiation antenna 400D can be adjusted.

Also, each dipole antenna connection switch 97 is switched to the lower side in the figure, and the stub 503D in dipole and the exclusive portion 502D of the electric-field radiation antenna 500D are connected. Moreover, each loop antenna connection switch 96 is switched to the lower side in the figure, and the stub 403D in loop and the exclusive portion 402D of the magnetic-field radiation antenna 400D are disconnected. As a result, the common antenna element portion 600D, the two stubs 503D in dipole, and the two exclusive portions 502D constitute the electric-field radiation antenna 500D, which is a dipole antenna. As a result, the antenna unit ANT2D for information acquisition can conduct radio communication in a range of a long distance from the antenna. At this time, the two stubs 403D in loop function as stubs for the electric-field radiation antenna 500D. That is, by setting the length of the two stubs 403D in loop as appropriate, impedance of the electric-field radiation antenna 500D can be adjusted.

As above, by means of dimension setting of each stub 503D in dipole and each stub 403D in loop, characteristic impedance of the magnetic-field radiation antenna 400D and the characteristic impedance of the electric-field radiation antenna 500D can be made equivalent. As a result, in either of the case in which the antenna 400D is made to function and the case in which the antenna 500D is made to function, only by connecting the single common matching circuit 650, impedance matching between the antenna and the feeding line can be carried out equally.

In the variation configured as above, the effect similar to that of the first variation can be obtained. In addition, by connecting the single common matching circuit 650 to the common antenna element portion 600D, impedance matching can be carried out. Therefore, the number of matching circuits can be reduced.

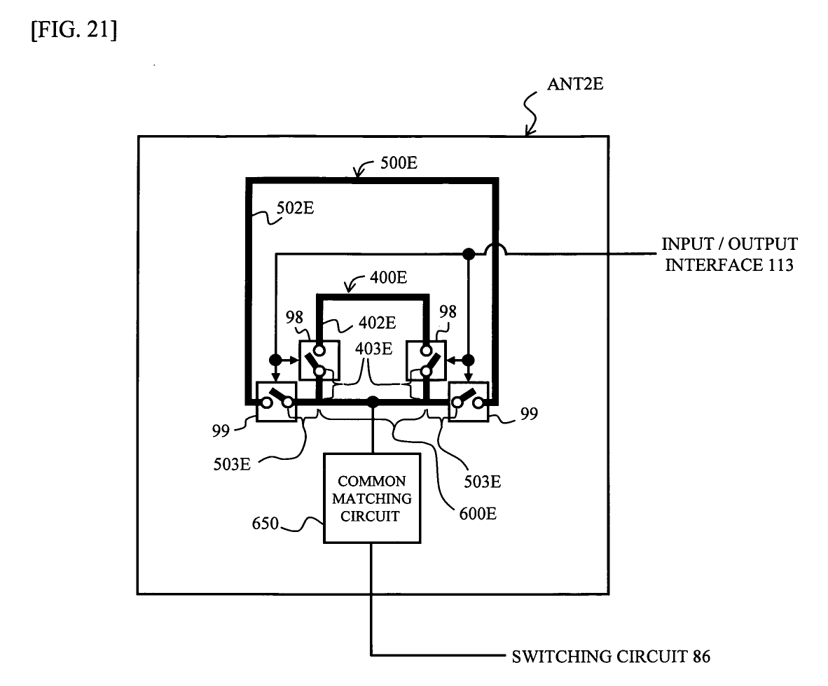

In this variation, too, the large-sized loop antenna (See FIGS. 15 and 19) can be applied instead of the dipole antenna as the electric-field radiation antenna 500D. In this case, as shown in FIG. 21, at both ends of a common antenna element portion 600E, stubs 403E, 403E in micro loop and a stub 503E in large-sized loop are formed. The stubs 403E in micro loop extend toward each end portion of an exclusive portion 402E of a magnetic-field radiation antenna 400E, respectively. The stubs 503E in large-sized loop extend toward each end portion of an exclusive portion 502E of an electric-field radiation antenna 500E, respectively. Also, at the distal ends of the stubs 403E, 503E, a micro loop connection switch 98 and a large-sized loop antenna connection switch 99 are disposed, respectively. The common antenna element portion 600E functions as the second common antenna element portion. The stub 403E in micro loop functions as the first antenna element for stub, and also functions as a matching device. The stub 503E in large-sized loop functions as the second antenna element for stub and also functions as the matching device. The micro loop connection switch 98 functions as the selection connecting device, and the large-sized loop antenna connection switch 99 also functions as the selection connecting device.

(3) When a Yagi antenna is configured using the magnetic-field radiation antenna and the electric-field radiation antenna:

In the above embodiment, the magnetic-field radiation antenna 400 and the electric-field radiation antenna 500 are arranged on the same plane. The present invention is not limited to that, but a Yagi antenna may be configured by arranging each antenna of a loop antenna type in parallel, for example.

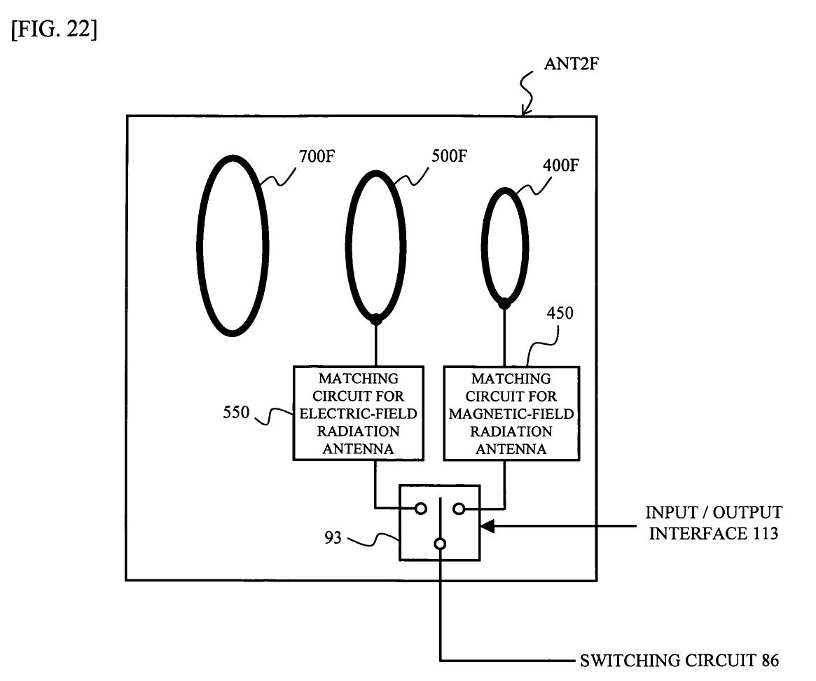

A configuration of an antenna unit ANT2F for information acquisition by such a variation is described by using FIG. 22.

In FIG. 22, the antenna unit ANT2F for information acquisition has a magnetic-field radiation antenna 400F, an electric-field radiation antenna 500F, and an antenna element 700F for reflector. Each of the antennas 400F, 500F, 700F is a substantially circular loop antenna. The magnetic-field radiation antenna 400F is a micro loop antenna. The entire peripheral length of the magnetic-field radiation antenna 400F is slightly shorter than a half wavelength, that is, λ/2. The electric-field radiation antenna 500F is a large-sized loop antenna. The entire peripheral length of the electric-field radiation antenna 500F is substantially equal to one wavelength λ. The antenna 700F for reflector is a loop antenna. The entire peripheral length of the antenna 700F for reflector is longer than one wavelength λ. In FIG. 22, each of the antennas 400F, 500F, 700F is shown in an elliptic shape in a perspective view.

Also, the three antennas 400F, 500F, 700F are disposed such that the electric-field radiation antenna 500F is arranged at the center and they are on the same straight line and in parallel with each other. To the magnetic-field radiation antenna 400F, the matching circuit 450 for magnetic-field radiation antenna is connected, while to the electric-field radiation antenna 500F, the matching circuit 550 for electric-field radiation antenna is connected.

In the above configuration, on the basis of a control signal from the control circuit 110 through the input/output interface 113, the connection switch 93 connects the switching circuit 86 to the matching circuit 450 for magnetic-field radiation antenna. In this case, the magnetic-field radiation antenna 400F functions singularly. Then, the antenna unit ANT2F for information acquisition can conduct radio communication in a range of a short distance from the antenna.

Also, on the basis of the control signal from the control circuit 110 through the input/output interface 113, the connection switch 93 connects the witching circuit 86 to the matching circuit 550 for electric-field radiation antenna. In this case, the relatively small magnetic-field radiation antenna 400F functions as a wave director, the relatively large antenna element 700F for reflector functions as a reflector, and the electric-field radiation antenna 500F functions as a radiator. As a result, the entire antenna unit ANT2F for information acquisition constitutes the Yagi antenna and can conduct radio communication in a range of a long distance from the antenna.

In the variation configured as above, the effect similar to that of the above embodiment can be also obtained. In addition to that, when the electric-field radiation antenna 500F is used, a characteristics of the Yagi antenna that a directivity is made sensitive and a high gain can be obtained is realized. Each of the loop antennas 400F, 500F, 700F is not limited to a circular shape but may be a square or polygon.

Other than those described above, methods of the embodiments and each variation may be combined as appropriate for use.

Also, in the above embodiments, the magnetic-field radiation antenna 400 and the electric-field radiation antenna 500 are used as the antenna unit ANT2 for information acquisition of the apparatus 1 for communicating with an RFID tag. However, the device to be used is not limited to the antennas 400, 500. That is, as the antenna for an exclusive device configured to obtain RFID tag information, combination of the magnetic-field radiation antenna 400 and the electric-field radiation antenna 500 may be used. Also, a shape of the device to be used is not limited to an installed type. That is, as an antenna of a handheld type RFID tag reader/writer, the combination of the magnetic-field radiation antenna 400 and the electric-field radiation antenna 500 may be used.

Though not specifically exemplified, the present invention should be put into practice with various changes made in a range not departing from its gist.

What is claimed is:

1. An antenna device connected to a signal generating device configured to generate a communication signal to a communication target, comprising:
a magnetic-field radiation antenna and an electric-field radiation antenna configured to carry out information transmission and reception via radio communication at substantially the same frequency with each other; and
a selection connecting device configured to selectively connect either one of said magnetic-field radiation antenna and said electric-field radiation antenna to said signal generating device.

2. The antenna device according to claim 1, wherein:
said magnetic-field radiation antenna and said electric-field radiation antenna are configured to conduct information transmission and reception with a radio frequency identification (RFID) tag circuit element by means of a communication signal to said RFID tag circuit element, said communication signal being generated by said signal generating device, said RFID circuit element having an IC circuit part storing information and a tag antenna for information transmission and reception.

3. The antenna device according to claim 1, wherein:
said magnetic-field radiation antenna is a small-sized loop antenna having a peripheral length of ½ or less of a wavelength of a communication wave.

4. The antenna device according to claim 1, wherein:
said electric-field radiation antenna is one of a dipole antenna, a micro strip antenna and a loop antenna having a peripheral length substantially equal to a wavelength of a communication wave.

5. The antenna device according to claim 1, wherein:
said selection connecting device selectively connects said magnetic-field radiation antenna or said electric-field radiation antenna to said signal generating device in a predetermined order by an automatic switching.

6. The antenna device according to claim 5, wherein:
said selection connecting device connects said magnetic-field radiation antenna and said electric-field radiation antenna by turns to said signal generating device till a predetermined communication result is obtained.

7. The antenna device according to claim 5, wherein:
said selection connecting device first connects said magnetic-field radiation antenna to said signal generating device, and next connects said electric-field radiation antenna to said signal generating device if a predetermined communication result is not obtained.

8. The antenna device according to claim 1, further comprising a matching device configured to match impedance on a side of each antenna to impedance on a side of said signal generating device when said magnetic-field radiation antenna or said electric-field radiation antenna is selectively connected to said signal generating device.

9. The antenna device according to claim 8, wherein:
said matching device includes a matching circuit for magnetic-field radiation antenna connected to said magnetic-field radiation antenna and a matching circuit for electric-field radiation antenna connected to said electric-field radiation antenna.

10. The antenna device according to claim 9, wherein:
said magnetic-field radiation antenna and said electric-field radiation antenna mutually share a first common antenna element portion configured to function as a part of said magnetic-field radiation antenna when said selection connecting device is switched to a side of said magnetic-field radiation antenna and to function as a part of said electric-field radiation antenna when said selection connecting device is switched to a side of said electric-field radiation antenna.

11. The antenna device according to claim 8, wherein:
said magnetic-field radiation antenna and said electric-field radiation antenna mutually share a second common antenna element portion configured to function as a part of said magnetic-field radiation antenna when said selection connecting device is switched to a side of said magnetic-field radiation antenna and to function as a part of said electric-field radiation antenna when said selection connecting device is switched to a side of said electric-field radiation antenna; and
said matching device has a single common matching circuit connected to said second common antenna element portion.

12. The antenna device according to claim 11, wherein:
said matching device includes:
a first stub antenna element connected to said second common antenna element portion and provided at said magnetic-field radiation antenna and configured to match impedance of said electric-field radiation antenna when said selection connecting device is switched to the side of said electric-field radiation antenna; and
a second stub antenna element connected to said second common antenna element portion and provided at said electric-field radiation antenna and configured to match impedance of said magnetic-field radiation antenna when said selection connecting device is switched to the side of said magnetic-field radiation antenna.

13. The antenna device according to claim 1, wherein:
said magnetic-field radiation antenna and said electric-field radiation antenna are arranged so that a direction of a main lobe of said magnetic-field radiation antenna and a direction of a main lobe of said electric-field radiation antenna are overlapped with each other.

14. The antenna device according to claim 13, wherein:
said magnetic-field radiation antenna and said electric-field radiation antenna are arranged so that a communicable area of said magnetic-field radiation antenna and a communicable area of said electric-field radiation antenna are partially overlapped with each other.

15. The antenna device according to claim 1, wherein:
at least one of said magnetic-field radiation antenna and said electric-field radiation antenna is configured as an antenna common to transmission and reception.

16. An apparatus for communicating with an RFID tag, comprising:
a signal generating device configured to generate a communication signal to an RFID tag circuit element having an IC circuit part storing information and a tag antenna for information transmission and reception;
a magnetic-field radiation antenna and an electric-field radiation antenna configured to carry out radio communication with said RFID tag circuit element at substantially the same frequency with each other; and
a selection connecting device configured to selectively connect either one of said magnetic-field radiation antenna and said electric-field radiation antenna to said signal generating device.

17. The apparatus according to claim 16, further comprising a control portion configured to control said selection connecting device so that said magnetic-field radiation antenna or said electric-field radiation antenna is connected to said signal generating device in a predetermined order by an automatically switching.

18. The apparatus according to claim 17, wherein:
said control portion controls said selection connecting device so that said magnetic-field radiation antenna and said electric-field radiation antenna are by turns connected to said signal generating device so as to conduct communication till a predetermined communication result is obtained.

19. The apparatus according to claim 17, wherein:
said control portion controls said selection connecting device so that said magnetic-field radiation antenna is first connected to said signal generating device, so as to conduct communication, and next said electric-field radiation antenna is connected to said signal generating device, so as to conduct communication if a predetermined communication result is not obtained.
